(19) United States
(12) Patent Application Publication
(10) Pub. No.: US 2026/0177759 A1
(43) Pub. Date: Jun. 25, 2026

(54) OPTICAL MODULE

(71) Applicant: HISENSE BROADBAND MULTIMEDIA TECHNOLOGIES CO., LTD., Qingdao (CN)

(72) Inventors: Wei CUI, Qingdao (CN); Hongchao PAN, Qingdao (CN); Can TONG, Qingdao (CN)

(21) Appl. No.: 19/539,968

(22) Filed: Feb. 13, 2026

Related U.S. Application Data
(63) Continuation of application No. PCT/CN2024/112467, filed on Aug. 15, 2024.

(30) Foreign Application Priority Data
Aug. 18, 2023 (CN) 202322230653.6
Aug. 18, 2023 (CN) 202322238470.9
Jan. 31, 2024 (CN) 202410134665.5

(51) Int. Cl. G02B 6/38; G02B 6/42

(52) U.S. Cl. CPC G02B 6/3893; G02B 6/3821; G02B 6/3885; G02B 6/3888; G02B 6/4292

(57) ABSTRACT

An optical module including: a circuit board, an optical transceiver component and an optical fiber adapter connected to the optical transceiver component via an optical fiber ribbon and to an external optical fiber. The optical transceiver component including lower and upper clamping jaw shells forming a clamping jaw with a light-transmitting hole, the lower clamping jaw shell includes a fixing component connecting the external optical fiber and a support component, the upper clamping jaw shell includes an upper shell cover plate configured to cover an opening of the support component and upper shell side plates; and an optical fiber plug received in the clamping jaw and connecting with the optical fiber ribbon. The support component is provided with connecting protrusions, the upper shell side plates are provided with mounting holes matching with the connecting protrusions to connect the upper clamping jaw shell with the lower clamping jaw shell.

The present disclosure is a continuation application of International Application No. PCT/CN 2024/112467, filed on Aug. 15, 2024, which claims priority to Chinese Patent Application No. 202322238470.9, filed with the China National Intellectual Property Administration on Aug. 18, 2023, claims priority to Chinese Patent Application No. 202322230653.6, filed with the China National Intellectual Property Administration on Aug. 18, 2023, and claims priority to Chinese Patent Application No. 202410134665.5, filed with the China National Intellectual Property Administration on Jan. 31, 2024, all of the above-mentioned applications are incorporated herein by reference in their entirety.

### FIELD OF THE INVENTION

The present disclosure relates to the field of optical fiber communication technology, and in particular, to an optical module.

### BACKGROUND OF THE INVENTION

With the development of new services and application models such as cloud computing, mobile Internet, and video, advances in optical communication technology have become increasingly important. In optical communication technology, the optical module is a device for enabling the conversion between optical and electrical signals, one of the key devices in optical communication equipment, and occupies a core position in optical communication.

### SUMMARY OF THE INVENTION

In a first aspect, an embodiment of the present disclosure provides an optical module, including:
an upper shell, where a first optical fiber socket mounting portion is formed at an end of the upper shell close to an optical port;
a lower shell, where a second optical fiber socket mounting portion is formed at an end of the lower shell close to the optical port, the second optical fiber socket mounting portion is in covered connection with the first optical fiber socket mounting portion, and the second optical fiber socket mounting portion and the first optical fiber socket mounting portion form an optical fiber socket mounting cavity;
a first optical fiber, where one end of the first optical fiber is located outside the optical module, the other end of the first optical fiber is provided with a second optical fiber connecting component, and an end of the second optical fiber connecting component is located in the optical fiber socket mounting cavity and is in contact connection with the optical fiber socket mounting cavity; and
a second optical fiber, located inside the optical module and having one end connected to the second optical fiber connecting component,
where the second optical fiber connecting component includes a second optical fiber connector and a second optical fiber protective sleeve; the second optical fiber protective sleeve is sleeved on the first optical fiber, one end of the second optical fiber connector is connected to the second optical fiber protective sleeve, and the other end of the second optical fiber connector is connected to one end of the second optical fiber; an outer edge of an end of the second optical fiber protective sleeve is in assembled connection with the optical fiber socket mounting cavity, and an outer edge of the second optical fiber connector is in assembled connection with the optical fiber socket mounting cavity;
alternatively, the other end of the first optical fiber is provided with a first optical fiber connecting component, and an end of the first optical fiber connecting component is located in the optical fiber socket mounting cavity; and the second optical fiber is connected to the first optical fiber connecting component. The optical module further includes:
a clamping component, sleeved on the first optical fiber connecting component, where an inner side of the clamping component is cooperatively connected to the first optical fiber connecting component, and an outer side of the clamping component is cooperatively connected to the optical fiber socket mounting cavity, thereby fixedly connecting the first optical fiber connecting component to the optical fiber socket mounting cavity; and the clamping component includes:
a lower clamping jaw shell, including:
a fixing component, where a light-transmitting hole runs through the fixing component;
a support component, in communication with the fixing component, where an upper surface of the support component is provided with an opening, and the opening is in communication with the light-transmitting hole;
an upper clamping jaw shell, covering the lower clamping jaw shell to form a clamping jaw with the light-transmitting hole, where the upper clamping jaw shell includes:
an upper shell cover plate, disposed at the opening of the support component;
an upper shell support arm, located on one side of the upper shell cover plate and connected to the support component;
an optical fiber plug, having one end fixedly provided with an optical fiber ribbon, and the other end inserted into the light-transmitting hole; and
a limiting member, disposed in the clamping jaw, and having one end in contact with an end face of the optical fiber plug, and the other end in contact connection with the lower clamping jaw shell,
where one side wall of the support component is provided with a connecting protrusion protruding from an outer wall of the support component, the upper shell support arm is provided with a mounting hole, and the connecting protrusion is embedded in the mounting hole.

In a second aspect, an embodiment of the present disclosure provides an optical module, including:
a circuit board;
an optical transceiver component, electrically connected to the circuit board and configured to emit and receive an optical signal; and
an optical fiber adapter, having a first end connected to an external optical fiber plug of an external optical fiber, and a second end connected to the optical transceiver component via an optical fiber ribbon, where the second end of the optical fiber adapter is disposed opposite to the first end; and
the optical fiber adapter includes:
a lower clamping jaw shell, provided with a through light-transmitting hole, and including:
a fixing component, configured to accommodate the external optical fiber plug of the external optical fiber, where the light-transmitting hole runs through the fixing component;
a support component, connected to the fixing component, where an upper surface of the support component is provided with an opening, and the opening is in communication with the light-transmitting hole;
an upper clamping jaw shell, configured to cover the lower clamping jaw shell to form a clamping jaw with the light-transmitting hole, where the upper clamping jaw shell includes:
an upper shell cover plate, configured to cover the opening of the support component;
upper shell side plates, connected to two opposite sides of the upper shell cover plate and configured to be connected to corresponding outer walls of the support component; and
an optical fiber plug, having one end fixedly connected to the optical fiber ribbon, and the other end inserted into the light-transmitting hole,
where the outer walls of the support component are provided with connecting protrusions protruding from the outer walls, the upper shell side plates are provided with corresponding mounting holes, and the connecting protrusions are embedded in the mounting holes such that the upper clamping jaw shell is connected to the lower clamping jaw shell.

### BRIEF DESCRIPTION OF THE DRAWINGS

To illustrate the technical solutions in the present disclosure more clearly, a brief introduction to the drawings that need to be used in some embodiments of the present disclosure will be provided below. Apparently, the drawings described below are merely the drawings in some embodiments of the present disclosure. Those of ordinary skill in the art can also derive other drawings from these drawings. Furthermore, the drawings described below can be regarded as schematic diagrams and are not intended to limit the actual dimensions of the products, the actual processes of the methods, or the actual timing of the signals involved in the embodiments of the present disclosure.

FIG. 1 is a partial structural diagram of an optical communication system according to some embodiments of the present disclosure;

FIG. 2 is a partial structural diagram of a host computer according to some embodiments of the present disclosure;

FIG. 3 is a structural diagram of an optical module according to some embodiments of the present disclosure;

FIG. 4 is an exploded view of an optical module according to some embodiments of the present disclosure;

FIG. 5 is a schematic diagram of a partial structure of an optical module with a pigtail according to some embodiments of the present disclosure;

FIG. 6 is a schematic structural diagram of an upper shell according to some embodiments of the present disclosure;

FIG. 7 is a schematic structural diagram of a lower shell according to some embodiments of the present disclosure;

FIG. 8 is a schematic structural diagram of another optical module according to some embodiments of the present disclosure;

FIG. 9 is a schematic exploded view of another optical module according to some embodiments of the present disclosure;

FIG. 10 is a schematic internal exploded view of another optical module according to some embodiments of the present disclosure;

FIG. 11 is a first schematic structural diagram of a clamping component according to some embodiments of the present disclosure;

FIG. 12 is a second schematic structural diagram of a clamping component according to some embodiments of the present disclosure;

FIG. 13 is a schematic structural diagram of an upper engaging component according to some embodiments of the present disclosure;

FIG. 14 is a schematic structural diagram of a lower engaging component according to some embodiments of the present disclosure;

FIG. 15 is a usage state diagram of an engaging component according to some embodiments of the present disclosure;

FIG. 16 is a schematic exploded view of yet another optical module according to some embodiments of the present disclosure;

FIG. 17 is a schematic diagram of an internal structure of yet another optical module according to some embodiments of the present disclosure;

FIG. 18 is a usage state diagram of a second optical fiber connecting component according to some embodiments of the present disclosure;

FIG. 19 is a schematic structural diagram of a second optical fiber connecting component according to some embodiments of the present disclosure;

FIG. 20 is an exploded view of a second optical fiber connecting component according to some embodiments of the present disclosure;

FIG. 21 is a schematic structural diagram of a second optical fiber protective sleeve according to some embodiments of the present disclosure;

FIG. 22 is an exploded view of another second optical fiber connecting component according to some embodiments of the present disclosure;

FIG. 23 is a schematic structural diagram of a second optical fiber connector according to some embodiments of the present disclosure;

FIG. 24 is a schematic assembly diagram of a second optical fiber connecting component and a lower shell according to some embodiments of the present disclosure;

FIG. 25 is a schematic diagram of a circuit board, an optical transceiver component, an optical fiber adapter, and an optical fiber plug in an optical module according to an embodiment of the present disclosure;

FIG. 26 is a schematic structural diagram of an optical fiber adapter in an optical module according to an embodiment of the present disclosure;

FIG. 27 is a schematic exploded view of an optical fiber adapter in an optical module according to an embodiment of the present disclosure;

FIG. 28 is a first schematic cross-sectional view of an optical fiber adapter in an optical module according to an embodiment of the present disclosure;

FIG. 29 is a schematic structural diagram of a pin according to some embodiments of the present disclosure;

FIG. 30 is a schematic structural diagram of an optical fiber protective portion according to some embodiments of the present disclosure;

FIG. 31 is a schematic structural diagram of an optical fiber plug according to some embodiments of the present disclosure;

FIG. 32 is a schematic structural diagram of a limiting member according to an embodiment of the present disclosure;

FIG. 33 is a schematic cross-sectional view of a combination of a limiting member, an optical fiber protective portion, an optical fiber plug, and a pin according to an embodiment of the present disclosure;

FIG. 34 is a schematic exploded view of a clamping jaw in an optical fiber adapter according to an embodiment of the present disclosure;

FIG. 35 is a schematic cross-sectional view of a clamping jaw in an optical fiber adapter according to an embodiment of the present disclosure;

FIG. 36 is a first-angle schematic structural diagram of an upper clamping jaw shell in an optical fiber adapter according to an embodiment of the present disclosure;

FIG. 37 is a second-angle schematic structural diagram of an upper clamping jaw shell in an optical fiber adapter according to an embodiment of the present disclosure;

FIG. 38 is a first-angle schematic structural diagram of a lower clamping jaw shell in an optical fiber adapter according to an embodiment of the present disclosure;

FIG. 39 is a second-angle schematic structural diagram of a lower clamping jaw shell in an optical fiber adapter according to an embodiment of the present disclosure;

FIG. 40 is a schematic cross-sectional view of a lower clamping jaw shell in an optical fiber adapter according to an embodiment of the present disclosure;

FIG. 41 is a schematic diagram of a mounting process for an optical fiber adapter according to some embodiments of the present disclosure; and

FIG. 42 is a second schematic cross-sectional view of an optical fiber adapter in an optical module according to some embodiments of the present disclosure.

### DETAILED DESCRIPTION OF THE EMBODIMENTS

The technical solutions in some embodiments of the present disclosure will be clearly and detailedly described below with reference to the accompanying drawings. Apparently, the described embodiments are merely some rather than all of the embodiments of the present disclosure. All other embodiments obtained by those of ordinary skill in the art based on the embodiments provided in the present disclosure fall within the scope of protection of the present disclosure.

In optical communication technology, in order to establish information transmission between information processing devices, it is necessary to load information onto light and use the propagation of light to implement the transmission of information. Here, the light loaded with information is an optical signal. When the optical signal is transmitted in the information transmission devices, the loss of optical power can be reduced, such that high-speed, long-distance, and low-cost information transmission can be achieved. The signals that the information processing devices are able to recognize and process are electrical signals. The information processing devices usually include optical network units (ONUs), gateways, routers, switches, mobile phones, computers, servers, tablet computers, televisions, etc. The information transmission devices usually include optical fibers and optical waveguides.

The optical modules enable the conversion between optical signals and electrical signals from the information processing devices and the information transmission devices. For example, at least one of an optical signal input or an optical signal output of an optical module is connected to an optical fiber, and at least one of an electrical signal input or an electrical signal output of the optical module is connected to an optical network unit; a first optical signal from the optical fiber is transmitted to the optical module, and the optical module converts the first optical signal into a first electrical signal and transmits the first electrical signal to the optical network unit; and a second electrical signal from the optical network unit is transmitted to the optical module, and the optical module converts the second electrical signal into a second optical signal and transmits the second optical signal to the optical fiber. Since information can be transmitted through electrical signals between a plurality of information processing devices, at least one information processing device in the plurality of information processing devices is required to be directly connected to the optical module, and all information processing devices are not required to be directly connected to the optical module. Here, the information processing device directly connected to the optical module is referred to as a host computer of the optical module. In addition, the optical signal input or the optical signal output of the optical module can be referred to as an optical port, and the electrical signal input or the electrical signal output of the optical module can be referred to as an electrical port.

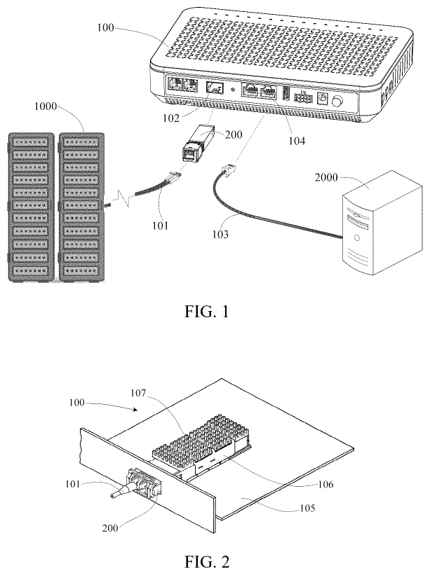

FIG. 1 is a partial structural diagram of an optical communication system according to some embodiments of the present disclosure. As shown in FIG. 1, the optical communication system primarily includes a remote information processing device 1000, a local information processing device 2000, a host computer 100, an optical module 200, an optical fiber 101 and a network cable 103.

One end of the optical fiber 101 extends toward the remote information processing device 1000, and the other end of the optical fiber 101 is connected to the optical module 200 via an optical port of the optical module 200. An optical signal can undergo total reflection in the optical fiber 101, and the propagation of the optical signal in the total reflection direction can make it nearly maintain its original optical power. The optical signal undergoes multiple total reflections in the optical fiber 101 to transmit an optical signal from the remote information processing device 1000 to the optical module 200 or to transmit an optical signal from the optical module 200 to the remote information processing device 1000, thereby achieving long-distance and low-power-loss information transmission.

The optical communication system may include one or more optical fibers 101, and the optical fiber 101 is detachably or fixedly connected to the optical module 200. The host computer 100 is configured to provide a data signal to the optical module 200, receive a data signal from the optical module 200, or monitor or control a working state of the optical module 200.

The host computer 100 includes a generally cuboid-shaped housing and an optical module interface 102 disposed on the housing. The optical module interface 102 is configured to be connected to the optical module 200, enabling the host computer 100 to establish a one-way or two-way electrical signal connection with the optical module 200.

The host computer 100 further includes an external electrical interface that can be connected to an electrical signal network. For example, the external electrical interface includes a universal serial bus (USB) interface or a network cable interface 104. The network cable interface 104 is configured to be connected to the network cable 103, enabling the host computer 100 to establish a one-way or two-way electrical signal connection with the network cable 103. One end of the network cable 103 is connected to the local information processing device 2000, and the other end of the network cable 103 is connected to the host computer 100, thereby establishing an electrical signal connection between the local information processing device 2000 and the host computer 100 via the network cable 103. For example, a third electrical signal sent by the local information processing device 2000 is transmitted to the host computer 100 via the network cable 103. The host computer 100 generates a second electrical signal according to the third electrical signal. The second electrical signal from the host computer 100 is transmitted to the optical module 200. The optical module 200 converts the second electrical signal into a second optical signal and transmits the second optical signal to the optical fiber 101. The second optical signal is transmitted through the optical fiber 101 to the remote information processing device 1000. For example, a first optical signal from the remote information processing device 1000 is transmitted through the optical fiber 101. The first optical signal from the optical fiber 101 is transmitted to the optical module 200. The optical module 200 converts the first optical signal into a first electrical signal, and then the optical module 200 transmits the first electrical signal to the host computer 100. The host computer 100 generates a fourth electrical signal according to the first electrical signal and transmits the fourth electrical signal to the local information processing device 2000. It should be noted that the optical module is a tool to achieve the conversion between optical signals and electrical signals. In the conversion between the optical signals and the electrical signals, the information remains unchanged, and the encoding and decoding methods for the information may vary.

In addition to the optical network unit, the host computer 100 further includes an optical line terminal (OLT), an optical network terminal (ONT), or a data center server.

FIG. 2 is a partial structural diagram of a host computer according to some embodiments. To clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105 disposed in the housing, a cage 106 disposed on the surface of the PCB 105, a heat sink 107 disposed on the cage 106, and an electrical connector disposed inside the cage 106. The electrical connector is configured to be connected to the electrical port of the optical module 200. The heat sink 107 has protruding structures such as fins that enlarge the heat dissipation area.

The optical module 200 is inserted into the cage 106 of the host computer 100, and the optical module 200 is fixed by the cage 106. The heat generated by the optical module 200 is conducted to the cage 106 and then diffused through the heat sink 107. After the optical module 200 is inserted into the cage 106, the electrical port of the optical module 200 is connected to the electrical connector inside the cage 106, such that the optical module 200 establishes a two-way electrical signal connection with the host computer 100. In addition, the optical port of the optical module 200 is connected to the optical fiber 101, such that the optical module 200 establishes a two-way optical signal connection with the optical fiber 101.

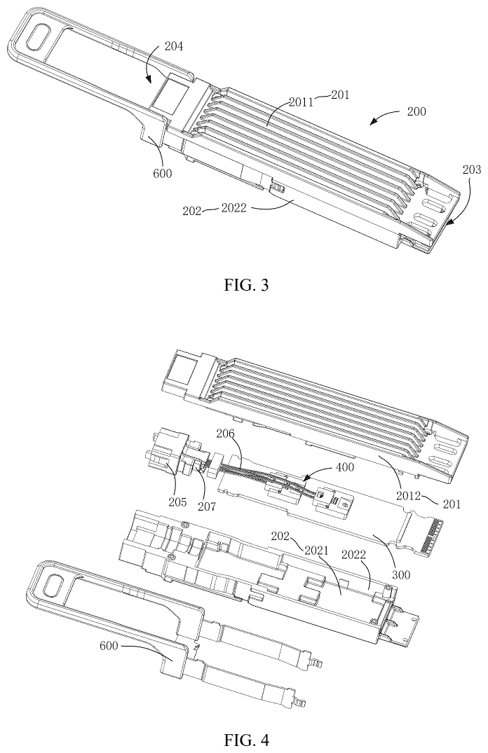

FIG. 3 is a structural diagram of an optical module according to some embodiments of the present disclosure, and FIG. 4 is an exploded view of an optical module according to some embodiments of the present disclosure. As shown in FIGS. 3 and 4, the optical module 200 includes a shell, and a circuit board 300 and an optical transceiver component 400 disposed in the shell.

The shell includes an upper shell 201 and a lower shell 202, where the upper shell 201 is covered on the lower shell 202 to form the shell with an opening 203 and an opening 204; and an outer contour of the shell is generally square.

In some embodiments, the lower shell 202 includes a bottom plate 2021 and two lower side plates 2022 located on two sides of the bottom plate 2021 and perpendicular to the bottom plate 2021; and the upper shell 201 includes a cover plate 2011, where the cover plate 2011 is covered on the two lower side plates 2022 of the lower shell 202 to form the shell.

In some embodiments, the lower shell 202 includes a bottom plate 2021 and two lower side plates 2022 located on two sides of the bottom plate 2021 and perpendicular to the bottom plate 2021; and the upper shell 201 includes a cover plate 2011 and two upper side plates 2012 located on two sides of the cover plate 2011 and perpendicular to the cover plate 2011, where the two upper side plates 2012 and the two lower side plates 2022 are combined to ensure that the upper shell 201 covers the lower shell 202.

A direction of a connecting line between the opening 203 and the opening 204 may be consistent with a length direction of the optical module 200 or may be inconsistent with the length direction of the optical module 200. For example, the opening 203 is located at an end of the optical module 200 (the left end of FIG. 3), and the opening 204 is also located at an end of the optical module 200 (the right end of FIG. 3). Alternatively, the opening 203 is located at an end of the optical module 200, and the opening 204 is located on a side of the optical module 200. The opening 203 is an electrical port, and a gold finger of the circuit board 300 extends out from the electrical port and is inserted into the host computer (e.g., an optical network unit 100); and the opening 204 is an optical port, which is configured to access the optical fiber 101 such that the optical fiber 101 is connected into the optical module 200.

The assembly method of combining the upper shell 201 with the lower shell 202 is adopted, such that the circuit board 300, the optical transceiver component 400, and other components can be conveniently mounted in the shell, and these components can be packaged and protected by the upper shell 201 and the lower shell 202. In addition, when the circuit board 300, the optical transceiver component 400, and other components are assembled, it facilitates the deployment of positioning parts, heat dissipation parts, and electromagnetic shielding parts of these components, which is conducive to automated production.

In some embodiments, the upper shell 201 and the lower shell 202 are made of a metal material, which is conducive to electromagnetic shielding and heat dissipation.

In some embodiments, the optical module 200 further includes an unlocking component 600 located outside the shell, where the unlocking component 600 is configured to achieve a fixed connection between the optical module 200 and the host computer, or to release the fixed connection between the optical module 200 and the host computer.

For example, the unlocking component 600 is located outside the two lower side plates 2022 of the lower shell 202, and includes a clamping component that matches the cage 106 of the host computer 100. When the optical module 200 is inserted into the cage 106, the optical module 200 is fixed in the cage 106 by the clamping component of the unlocking component 600; and when the unlocking component 600 is pulled, the clamping component of the unlocking component 600 moves accordingly, such that the connection relationship between the clamping component and the host computer is changed to release the fixation between the optical module 200 and the host computer, thereby pulling out the optical module 200 from the cage 106.

The circuit board 300 includes circuit traces, electronic components, and chips, where the electronic components and the chips are connected together through the circuit traces according to the circuit design to implement the functions such as power supply, electrical signal transmission, and grounding. The electronic components include, for example, capacitors, resistors, transistors, and metal-oxide-semiconductor field-effect transistors (MOSFETs). The chips include, for example, lasers, photodetectors, microcontroller units (MCUs), laser driver chips, limiting amplifiers (LAs), clock and data recovery (CDR) chips, power management chips, and digital signal processing (DSP) chips.

The circuit board 300 is generally a rigid circuit board. The rigid circuit board can also achieve a bearing effect because of its relatively hard material, for example, the rigid circuit board can stably carry the above-mentioned electronic components and chips. The rigid circuit board can also be inserted into the electrical connector in the cage 106 of the host computer 100.

The circuit board 300 further includes a gold finger formed on its end surface, where the gold finger consists of a plurality of pins that are independent of each other. The circuit board 300 is inserted into the cage 106 and is connected to the electrical connector in the cage 106 via the gold finger. The gold finger may be disposed only on a side surface of the circuit board 300 (such as the upper surface shown in FIG. 4), or may be disposed on upper and lower side surfaces of the circuit board 300 to provide more pins, so as to adapt to occasions requiring a large number of pins. The gold finger is configured to establish an electrical connection with the host computer to achieve power supply, grounding, two-wire inter-integrated circuit (I2C) signal transmission, data signal transmission, etc. Certainly, flexible circuit boards are also used in some optical modules. Flexible circuit boards are generally used in conjunction with rigid circuit boards as a supplement to rigid circuit boards.

An optical fiber socket 205 is disposed at the optical port of the optical module 200, and a second optical fiber 206 is disposed in the optical module 200; one end of the second optical fiber 206 is provided with an optical fiber adapter 207, where the optical fiber adapter 207 is embedded in the optical fiber socket 205; and the other end of the second optical fiber 206 is connected to the optical transceiver component 400. By way of example, the second optical fiber 206 is an optical fiber ribbon, including a plurality of optical fibers for transmitting multiple optical signals. An optical fiber connector is disposed on an external optical fiber, and an optical fiber plug is inserted into the optical fiber socket 205, such that the external optical fiber is coupled to the second optical fiber 206, where the optical fiber plug is pluggably connected to the optical fiber socket 205.

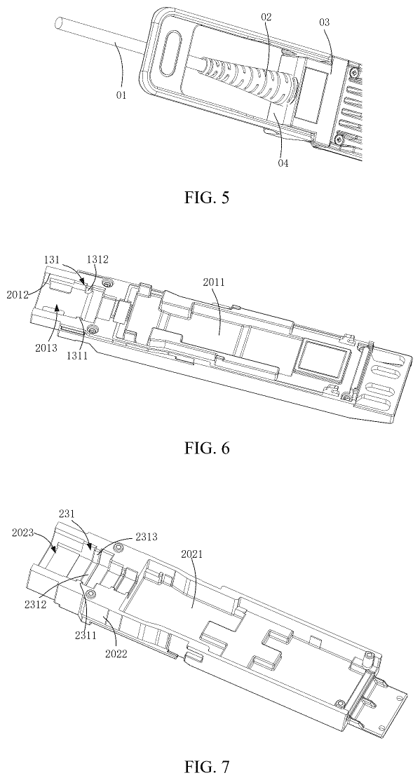

To adapt to usage scenarios of optical modules, some optical modules are provided with pigtails. In consideration of both the cost and the requirement for the connection firmness between the pigtail and the optical module, the pigtail is usually fixed directly to the optical module. In some embodiments, the pigtail and the second optical fiber 206 are continuous integral optical fibers, and an optical fiber connecting component is disposed at the optical port of the optical module, such that the pigtail is connected to the optical port of the optical module via the optical fiber connecting component. FIG. 5 is a schematic diagram of a partial structure of an optical module with a pigtail according to some embodiments of the present disclosure. As shown in FIG. 5, a protective sleeve 02 is disposed on the pigtail 01, and the protective sleeve 02 is embedded in the optical port of the optical module, such that the upper shell 03 and the lower shell 04 of the optical module wrap and fix the protective sleeve 02. By way of example, the protective sleeve 02 is of a cylindrical structure, and the optical port of the optical module is provided with a through hole formed by the upper shell 03 and the lower shell 04, where the protective sleeve is embedded in the through hole.

FIG. 6 is a schematic structural diagram of an upper shell according to some embodiments of the present disclosure, FIG. 7 is a schematic structural diagram of a lower shell according to some embodiments of the present disclosure, and FIG. 6 and FIG. 7 show a shell structure in which an optical fiber socket is disposed at an optical port of an optical module. As shown in FIG. 6 and FIG. 7, at an end close to the optical port of the optical module, a first optical fiber socket mounting portion 2013 is disposed on the upper shell 201, and a second optical fiber socket mounting portion 2023 is disposed on the lower shell 202. When the upper shell 201 is in covered connection with the lower shell 202, the first optical fiber socket mounting portion 2013 covers the second optical fiber socket mounting portion 2023 to form an optical fiber socket mounting cavity, which is configured to assemble and fix the optical fiber socket 205. By way of example, the first optical fiber socket mounting portion 2013 is a recess formed in one end of the upper shell 201, and the second optical fiber socket mounting portion 2023 is a recess formed in one end of the lower shell 202; and a side wall of the first optical fiber socket mounting portion 2013 and a side wall of the second optical fiber socket mounting portion 2023 are in assembled connection with the optical fiber socket 205.

In some embodiments, the first optical fiber socket mounting portion 2013 is provided with a first limiting protrusion 131, and the second optical fiber socket mounting portion 2023 is provided with a second limiting protrusion 231, where the first limiting protrusion 131 and the second limiting protrusion 231 are configured to be in limiting connection with the optical fiber socket 205. The first limiting protrusion 131 includes a first limiting portion 1311 and a second limiting portion 1312, where the first limiting portion 1311 is disposed on the upper side plate on one side of the cover plate 2011, and the second limiting portion 1312 is disposed on the upper side plate on the other side of the cover plate 2011. The second limiting protrusion 231 includes a third limiting portion 2311, a fourth limiting portion 2312, and a fifth limiting portion 2313, where the third limiting portion 2311 is disposed on the lower side plate on one side of the bottom plate 2021, the fourth limiting portion 2312 is disposed on the bottom plate, and the fifth limiting portion 2313 is disposed on the lower side plate on the other side of the bottom plate 2021. By way of example, one end of the fourth limiting portion 2312 is connected to the third limiting portion 2311, and the other end of the fourth limiting portion 2312 is connected to the fifth limiting portion 2313; and the second limiting protrusion 231 extends from the lower side plate on the right side of the lower shell 202, through the bottom plate, to the lower side plate on the left side.

The shape of the optical fiber socket 205 differs significantly from that of the protective sleeve on the pigtail, such that the upper shell 201 and the lower shell 202 adapted for the optical fiber socket 205 are not compatible with the protective sleeve on the pigtail. Therefore, to achieve the optical module with a pigtail shown in FIG. 3 and FIG. 4, the shell structure of the optical module needs to be adjusted. For example, new upper shell mold and lower shell mold matching the protective sleeve on the pigtail are made. However, making the upper shell mold and the lower shell mold is relatively time-consuming and costly, making it unsuitable for use in the production and manufacturing of optical modules.

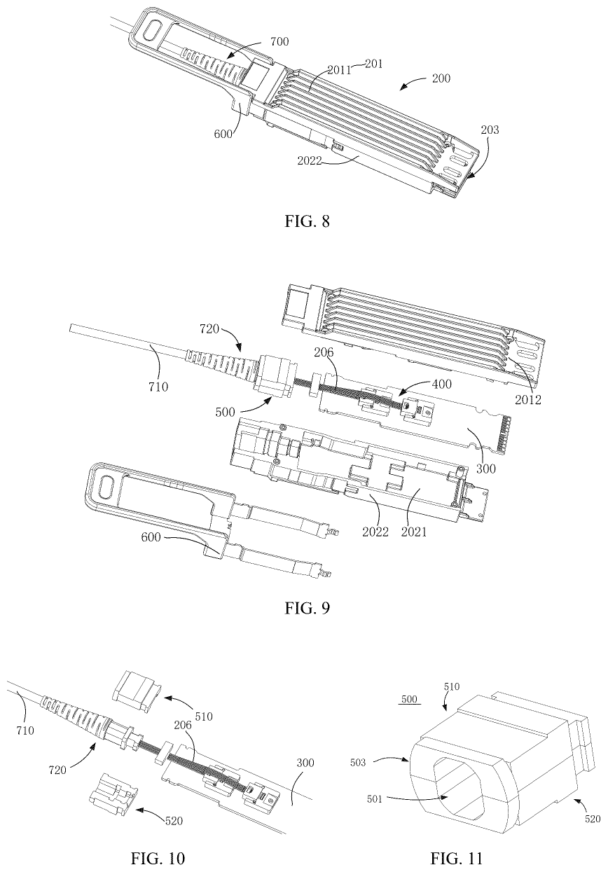

FIG. 8 is a schematic structural diagram of another optical module according to some embodiments of the present disclosure, and FIG. 9 is a schematic exploded view of another optical module according to some embodiments of the present disclosure. As shown in FIG. 8 and FIG. 9, the optical module 200 includes an upper shell 201, a lower shell 202, a circuit board 300, an optical transceiver component 400, a second optical fiber 206, and an unlocking component 600. The optical module 200 further includes a pigtail assembly 700 and a clamping component 500.

The pigtail assembly 700 includes a first optical fiber 710 and a first optical fiber connecting component 720, where the first optical fiber connecting component 720 is disposed on the first optical fiber 710, the first optical fiber 710 is coupled to the second optical fiber 206, the first optical fiber 710 is located outside a wrapping cavity formed by the upper shell 201 and the lower shell 202, and the second optical fiber 206 is located in the wrapping cavity formed by the upper shell 201 and the lower shell 202. In some embodiments, the first optical fiber 710 and the second optical fiber 206 are integral optical fibers.

The clamping component 500 is sleeved on the first optical fiber connecting component 720, and the clamping component 500 is cooperatively connected to the optical fiber socket mounting cavity to assemble and fix the pigtail assembly 700 with the upper shell 201 and the lower shell 202, such that the optical module is provided with a pigtail. Therefore, in the optical module provided by the embodiment of the present disclosure, the first optical fiber 710 is fixed in the optical fiber socket mounting cavity by the clamping component 500, such that on the basis of the structural members of the original optical module without a pigtail, the optical module is provided with a pigtail without changing the structures of the upper shell 201 and the lower shell 202 of the optical module. This also improves the versatility of the upper shell 201 and the lower shell 202, reduces the number of molds for the upper shell 201 and the lower shell 202, and lowers the development cost of the optical module.

FIG. 10 is a schematic internal exploded view of another optical module according to some embodiments of the present disclosure. As shown in FIG. 9 and FIG. 10, the clamping component 500 includes an upper engaging component 510 and a lower engaging component 520, where the upper engaging component 510 is in covered connection with the lower engaging component 520 to form an engaging cavity, and an end of the first optical fiber connecting component 720 is embedded in the engaging cavity, such that the clamping component 500 is fixedly connected to the first optical fiber connecting component 720 via the engaging cavity, thereby facilitating assembly connection between the clamping component 500 and the first optical fiber connecting component 720. The clamping component 500 may be made of a plastic material, which facilitates manufacturing and cost control of the clamping component 500.

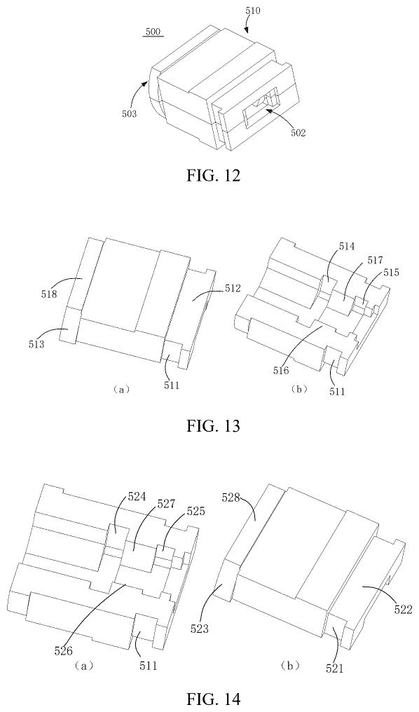

FIG. 11 is a first schematic structural diagram of a clamping component according to some embodiments of the present disclosure, and FIG. 12 is a second schematic structural diagram of a clamping component according to some embodiments of the present disclosure. As shown in FIG. 11 and FIG. 12, one end of the clamping component 500 is provided with a first opening 501, and the other end of the clamping component 500 is provided with a second opening 502, where the first opening 501 and the second opening 502 are respectively in communication with the engaging cavity. The first opening 501 is cooperatively connected to the end of the first optical fiber connecting component 720, allowing the first optical fiber 710 to pass through the first opening 501; and the second opening 502 is configured for the second optical fiber 206 to pass through, such that the clamping component 500 fixedly supports the second optical fiber 206. By way of example, both ends of the upper engaging component 510 and both ends of the lower engaging component 520 are respectively provided with semi-openings, and the semi-openings in the upper engaging component 510 cover the corresponding semi-openings in the lower engaging component 520 to form the first opening 501 and the second opening 502.

In some embodiments, one end of the clamping component 500 is provided with a sealing step 503, and the sealing step 503 is in embedded connection with to an end of the optical fiber socket mounting cavity. The sealing step 503 is configured to relatively seal the optical port of the optical module.

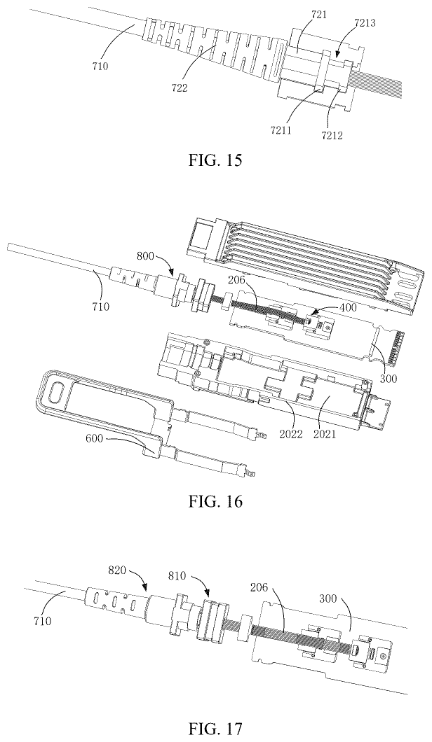

FIG. 13 is a schematic structural diagram of an upper engaging component according to some embodiments of the present disclosure, FIG. 14 is a schematic structural diagram of a lower engaging component according to some embodiments of the present disclosure, and FIG. 15 is a usage state diagram of an engaging component according to some embodiments of the present disclosure. In FIG. 13, (a) and (b) show a structure of an upper engaging component. In FIG. 14, (a) and (b) show a structure of a lower engaging component. In some embodiments, a positioning component is disposed on a contact surface of the upper engaging component 510 opposite to the lower engaging component 520, facilitating assembly of the upper engaging component 510 and the lower engaging component 520 via the positioning component. The positioning component includes a positioning hole and a positioning post. For example, the upper engaging component 510 is provided with the positioning post, and the lower engaging component 520 is provided with the positioning hole. The positioning post on the upper engaging component 510 is in assembled connection with the positioning hole on the lower engaging component 520.

In some embodiments, an outer side of the upper engaging component 510 is provided with a first limiting slot, and an outer side of the lower engaging component 520 is provided with a second limiting slot. The first limiting slot and the second limiting slot are cooperatively connected to the first limiting protrusion 131 and the second limiting protrusion 231, such that when the upper shell 201 is in covered connection with the lower shell 202, the first limiting protrusion 131 and the second limiting protrusion 231 are fixedly connected to the clamping component 500, thereby fixing the clamping component 500 in the optical fiber socket mounting cavity, and facilitating assembly and fixation of the clamping component 500 with the upper shell 201 and the lower shell 202.

In some embodiments, both side surfaces of the upper engaging component 510 are provided with first limiting slots 511, and both side surfaces of the lower engaging component 520 are provided with second limiting slots 521, where the first limiting slots 511 and the second limiting slots 521 are vertically disposed opposite to each other. The first limiting slot 511 is in limiting connection with the first limiting protrusion 131, thereby fixing the upper engaging component 510 in length and width directions of the optical module; and the second limiting slot 521 is in limiting connection with the second limiting protrusion 231, thereby fixing the lower engaging component 520 in the length and width directions of the optical module. By way of example, the first limiting portion 1311 and the second limiting portion 1312 are respectively in embedded connection with to the first limiting slot 511, and the third limiting portion 2311 and the fifth limiting portion 2313 are respectively in embedded connection with to the second limiting slot 521.

A first support surface 512 is disposed on a top surface of the upper engaging component 510, and both ends of the first support surface 512 extend to an edge of the first limiting slot 511. The bottom plate 2021 is in supporting connection with the first support surface 512. A second support surface 522 is disposed on a bottom surface of the lower engaging component 520, and both ends of the second support surface 522 extend to an edge of the second limiting slot 521. The fourth limiting portion 2312 is in supporting connection with the second support surface 522.

In some examples, the first limiting portion 1311 and the second limiting portion 1312 may be disposed on the upper engaging component 510. The first limiting slot 511 may be formed in the upper shell.

In some examples, the third limiting portion 2311 and the fifth limiting portion 2313 may be disposed on the lower engaging component 520. The second limiting slot 521 may be formed in the lower shell.

In some embodiments, one end of the upper engaging component 510 is provided with a first sealing step 513, and one end of the lower engaging component 520 is provided with a second sealing step 523, where the first sealing step 513 and the second sealing step 523 are aligned to form a sealing step. The first sealing step 513 is in embedded connection with to the first optical fiber socket mounting portion 2013, and the second sealing step 523 is in embedded connection with to the second optical fiber socket mounting portion 2023.

In some embodiments, a third support surface 518 is disposed on the first sealing step 513, and a fourth support surface 528 is disposed on the second sealing step 523, where the third support surface 518 is in contact connection with an inner wall surface of the cover plate 2011, and the fourth support surface 528 is in contact connection with an inner wall surface of the bottom plate 2021.

In some embodiments, the first optical fiber connecting component 720 includes a first optical fiber connector 721 and a first optical fiber protective sleeve 722, where one end of the first optical fiber connector 721 is connected to an end of the first optical fiber protective sleeve 722, the first optical fiber protective sleeve 722 is disposed on the first optical fiber 710 in a penetrating manner, and the end of the first optical fiber protective sleeve 722 or the first optical fiber connector 721 is fixedly connected to the clamping component 500. By way of example, the clamping component 500 is fixedly connected to the end of the first optical fiber protective sleeve 722, and the clamping component 500 is in embedded connection with to the first optical fiber connector 721. The first optical fiber protective sleeve 722 is a protective sleeve made of a flexible material such as rubber or silicone, which reduces damage at the optical port during bending of the first optical fiber 710.

In some embodiments, a first limiting platform 7211 and a second limiting platform 7212 are disposed on the first optical fiber connector 721, and a first gap 7213 is formed between the first limiting platform 7211 and the second limiting platform 7212, where a side edge of the first limiting platform 7211 is in limiting connection with the first optical fiber protective sleeve 722.

The upper engaging component 510 is provided with a first mounting slot 514 and a second mounting slot 515, a first spacer platform 516 and a second spacer platform 517 are disposed between the first mounting slot 514 and the second mounting slot 515, and a gap is formed between the first spacer platform 516 and the second spacer platform 517. A top of the first limiting platform 7211 is embedded in the first mounting slot 514, a top of the second limiting platform 7212 is embedded in the second mounting slot 515, and the first spacer platform 516 and the second spacer platform 517 are cooperatively connected to the first gap 7213.

The lower engaging component 520 is provided with a third mounting slot 524 and a fourth mounting slot 525, a third spacer platform 526 and a fourth spacer platform 527 are disposed between the third mounting slot 524 and the fourth mounting slot 525, and a gap is formed between the third spacer platform 526 and the fourth spacer platform 527. A bottom of the first limiting platform 7211 is embedded in the third mounting slot 524, a bottom of the second limiting platform 7212 is embedded in the fourth mounting slot 525, and the third spacer platform 526 and the fourth spacer platform 527 are cooperatively connected to the first gap 7213.

FIG. 16 is a schematic exploded view of yet another optical module according to some embodiments of the present disclosure. As shown in FIG. 16, the optical module 200 includes an upper shell 201, a lower shell 202, a circuit board 300, an optical transceiver component 400, a second optical fiber 206, and an unlocking component 600. The optical module 200 further includes a first optical fiber 710 and a second optical fiber connecting component 800, where the second optical fiber connecting component 800 is sleeved on the first optical fiber 710, the second optical fiber connecting component 800 is configured for coupling connection between the first optical fiber 710 and the second optical fiber 206, and the second optical fiber connecting component 800 is cooperatively connected to the optical fiber socket mounting cavity, such that the second optical fiber connecting component 800 supports and fixes the first optical fiber 710 and the second optical fiber 206. The first optical fiber 710 and the second optical fiber 206 may each be an integral optical fiber, with one end located outside the optical module and the other end located in the optical module; and the second optical fiber connecting component 800 is sleeved on the optical fiber, and the second optical fiber connecting component 800 is fixedly connected to the optical fiber and the shell of the optical module, such that the optical fiber is fixed to the optical module.

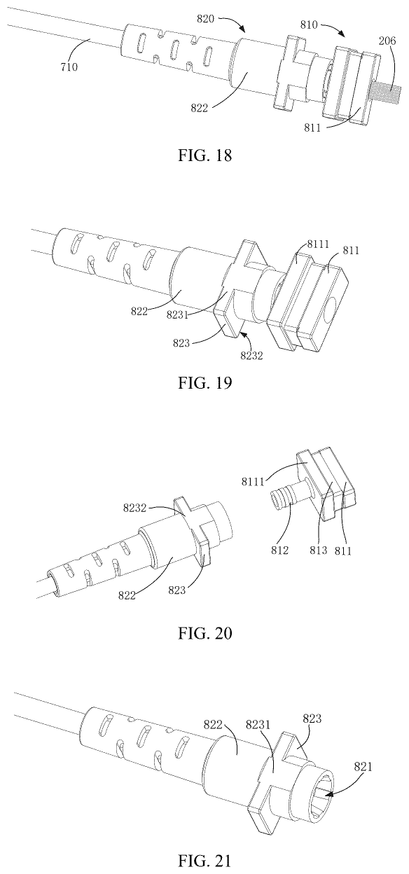

FIG. 17 is a schematic diagram of an internal structure of yet another optical module according to some embodiments of the present disclosure, and FIG. 18 is a usage state diagram of a second optical fiber connecting component according to some embodiments of the present disclosure. As shown in FIG. 17 and FIG. 18, the second optical fiber connecting component 800 includes a second optical fiber connector 810 and a second optical fiber protective sleeve 820, where the second optical fiber connector 810 is sleeved on the second optical fiber 206, the second optical fiber protective sleeve 820 is sleeved on the first optical fiber 710, and one end of the second optical fiber connector 810 is connected to the second optical fiber protective sleeve 820 to support the first optical fiber 710 and the second optical fiber 206, such that the first optical fiber 710 and the second optical fiber 206 are coupled to each other. Alternatively, the first optical fiber 710 and the second optical fiber 206 are integral optical fibers, and the second optical fiber connector 810 and the second optical fiber protective sleeve 820 are sleeved on the optical fiber to support the optical fiber. The second optical fiber connector 810 and the second optical fiber protective sleeve 820 are respectively cooperatively connected to the optical fiber socket mounting cavity, such that the second optical fiber connector 810 and the second optical fiber protective sleeve 820 are fixed in the optical fiber socket mounting cavity, thereby fixing the first optical fiber 710 and the second optical fiber 206. The second optical fiber protective sleeve 820 is a protective sleeve made of a flexible material such as rubber or silicone, which reduces damage at the optical port during bending of the first optical fiber 710.

In the optical module provided by the embodiment of the present disclosure, the second optical fiber connector 810 and the second optical fiber protective sleeve 820 support and are connected to the first optical fiber 710 and the second optical fiber 206, such that based on the original structural parts of the optical module without pigtails, the structure of the upper shell 201 and the lower shell 202 of the optical module is not changed, thereby enabling the optical module to have pigtails. This also improves the versatility of the upper shell 201 and the lower shell 202, reduces the number of molds for the upper shell 201 and the lower shell 202, and lowers the development cost of the optical module.

FIG. 19 is a schematic structural diagram of a second optical fiber connecting component according to some embodiments of the present disclosure, FIG. 20 is an exploded view of a second optical fiber connecting component according to some embodiments of the present disclosure, and FIG. 21 is a schematic structural diagram of a second optical fiber protective sleeve according to some embodiments of the present disclosure. The second optical fiber connector 810 includes an optical fiber support portion 811 and a connecting portion 812. One end of the connecting portion 812 is connected to the second optical fiber protective sleeve 820, and the other end of the connecting portion 812 is connected to the optical fiber support portion 811. The second optical fiber 206 runs through the optical fiber support portion 811, and the optical fiber support portion 811 fixedly supports the second optical fiber 206. A size of the connecting portion 812 is smaller than that of the optical fiber support portion 811. By way of example, the second optical fiber connector 810 is provided with a through hole running through the optical fiber support portion 811 and the connecting portion 812, and the second optical fiber 206 passes through the through hole and is fixedly supported via the through hole. In some embodiments, the second optical fiber connector 810 is a connector made of a metal material, and the second optical fiber connector 810 is in assembled connection with the optical fiber socket mounting cavity, which facilitates ensuring the electromagnetic shielding performance of the optical module to a certain extent.

In some embodiments, the second optical fiber protective sleeve 820 is provided with a connecting through hole 821, and the connecting portion 812 is embedded in the connecting through hole 821. By way of example, the connecting through hole 821 is a circular through hole, the connecting portion 812 is of a cylindrical structure, the size of the connecting portion 812 is smaller than that of an end of the second optical fiber protective sleeve 820, and a connecting protrusion is disposed on a cylindrical surface of the connecting portion 812; and the connecting portion 812 is embedded in the connecting through hole 821, and the connecting protrusion increases the connection firmness between the connecting portion 812 and the second optical fiber protective sleeve 820.

In some embodiments, a connector connecting portion 822 is disposed at the end of the second optical fiber protective sleeve 820, the connecting through hole 821 runs through the connector connecting portion 822, and the connector connecting portion 822 is connected to the second optical fiber connector 810. By way of example, the connecting portion 812 is fixedly connected to the connector connecting portion 822.

In some embodiments, a first connecting platform 823 is disposed on the connector connecting portion 822, and an edge of the first connecting platform 823 is in assembled connection with a side wall of the optical fiber socket mounting cavity. By way of example, a top of the first connecting platform 823 includes a first contact surface 8231, and a bottom of the first connecting platform 823 includes a second contact surface 8232, where the first contact surface 8231 is in contact connection with a top surface of an inner wall of the first optical fiber socket mounting portion 2013, and the second contact surface 8232 is in contact connection with a bottom surface of an inner wall of the second optical fiber socket mounting portion 2023. By way of example, the first connecting platform 823 is located at an edge of the optical port.

In some embodiments, an outer side of the optical fiber support portion 811 is provided with a second connecting platform 8111, the second connecting platform 8111 is disposed at one end of the optical fiber support portion 811, and a side edge of the second connecting platform 8111 is close to the connecting portion 812; and an edge of the second connecting platform 8111 is in assembled connection with the side wall of the optical fiber socket mounting cavity. A side surface of the second connecting platform 8111 away from the connecting portion 812 abuts against and is connected to a side surface of the first limiting protrusion 131 and a side surface of the second limiting protrusion 132.

In some embodiments, the second optical fiber connector 810 further includes a gasket 813, where the gasket 813 is sleeved on the optical fiber support portion 811, and the gasket 813 is configured to be in contact connection with an edge of the optical fiber support portion 811 and the side wall of the optical fiber socket mounting cavity. By way of example, the gasket 813 is in contact connection with the edge of the optical fiber support portion 811, a top surface of the first limiting protrusion 131, and a top surface of the second limiting protrusion 132.

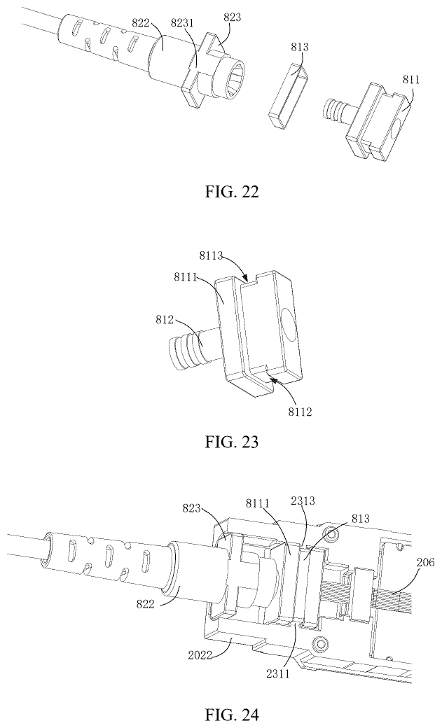

FIG. 22 is an exploded view of another second optical fiber connecting component according to some embodiments of the present disclosure, FIG. 23 is a schematic structural diagram of a second optical fiber connector according to some embodiments of the present disclosure, and FIG. 24 is a schematic assembly diagram of a second optical fiber connecting component and a lower shell according to some embodiments of the present disclosure. As shown in FIG. 22 to FIG. 24, one side of the optical fiber support portion 811 is provided with a first fixing slot 8112, the other side of the optical fiber support portion 811 is provided with a second fixing slot 8113, and the gasket 813 is sleeved on the first fixing slot 8112 and the second fixing slot 8113. The first fixing slot 8112 and the second fixing slot 8113 facilitate positioning and mounting of the gasket 813 on the optical fiber support portion 811. The third limiting portion 2311 and the fifth limiting portion 2313 abut against and are connected to the gasket 813, and the second connecting platform 8111 is located at side edges of the third limiting portion 2311 and the fifth limiting portion 2313.

In some examples, to facilitate the connection between the clamping component and the first optical fiber, the clamping component may include an optical fiber adapter. The following provides a detailed description of the optical fiber adapter in conjunction with some embodiments of the present disclosure.

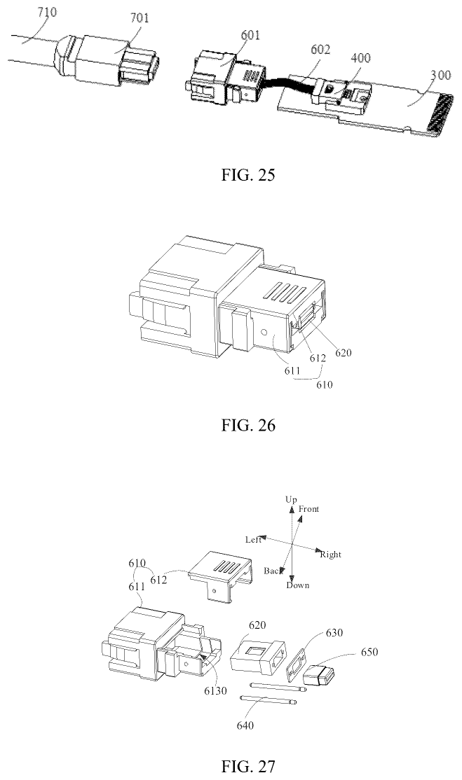

FIG. 25 is a schematic diagram of a circuit board, an optical transceiver component, an optical fiber adapter, and an optical fiber plug in an optical module according to an embodiment of the present disclosure. As shown in FIG. 25, the optical signal of the optical transceiver component 400 is transmitted via the optical fiber ribbon to the optical fiber adapter 601, and the optical fiber adapter 601 and an external optical fiber plug 701 connected to the optical fiber adapter 601 couple the optical signal to an external optical fiber 710, thereby achieving optical emission; and the optical signal transmitted by the external optical fiber 710 is transmitted to the optical fiber adapter 601 via the external optical fiber plug 701, and the optical fiber adapter 601 transmits the received optical signal to the optical transceiver component via the optical fiber ribbon, thereby achieving optical reception. Herein, for ease of description, one end of the optical fiber adapter connected to the external optical fiber plug 701 is referred to as a first end, and one end of the optical fiber adapter connected to the optical fiber ribbon is referred to as a second end, where the second end is opposite to the first end. In this embodiment, the external optical fiber serves as a first optical fiber, and the optical fiber ribbon connected between the optical transceiver component 400 and the optical fiber adapter 601 may serve as a second optical fiber.

In some embodiments, during use, the external optical fiber plug 701 is inserted into the optical fiber adapter 601, such that the optical signal transmitted by the optical fiber ribbon is coupled into the external optical fiber 710 via the optical fiber adapter 601, and the received optical signal transmitted by the external optical fiber 710 is transmitted to the optical transceiver component 400 via the optical fiber adapter 601.

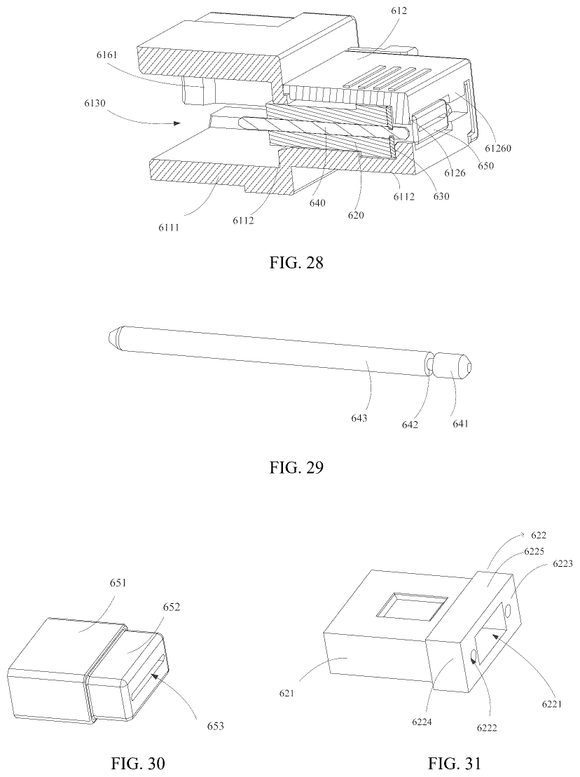

FIG. 26 is a schematic structural diagram of an optical fiber adapter in an optical module according to an embodiment of the present disclosure. FIG. 27 is a schematic exploded view of an optical fiber adapter in an optical module according to an embodiment of the present disclosure. FIG. 28 is a first schematic cross-sectional view of an optical fiber adapter in an optical module according to an embodiment of the present disclosure. As shown in FIG. 26, FIG. 27, and FIG. 28, in some embodiments, the optical fiber adapter 601 may include a clamping jaw 610, where a through light-transmitting hole 6130 is formed in the clamping jaw 610.

The optical fiber adapter 601 may include an optical fiber plug 620, where one end of the optical fiber plug 620 passing through the through light-transmitting hole is inserted into the clamping jaw 610. The external optical fiber plug 701 is inserted into the other end of the light-transmitting hole, and the external optical fiber plug 701 is coupled to the optical fiber plug 620, thereby achieving coupling connection between the optical fiber adapter 601 and the external optical fiber.

In some embodiments, the optical fiber plug 620 is clamped in the clamping jaw 610, and a right end of the optical fiber plug 620 may abut against an inner wall on one side of the clamping jaw.

The optical fiber adapter 601 may include a limiting member 630, where one end of the limiting member 630 may be in contact with an end face of the optical fiber plug 620, and the other end of the limiting member 630 is clamped to the clamping jaw 610, such that the optical fiber plug 620 is clamped in the clamping jaw 610 via the limiting member 630.

The limiting member 630 may be disposed between the optical fiber plug 620 and an inner wall of the clamping jaw 610.

The optical fiber adapter 601 may include a pin 640, where the pin 640 may run through the limiting member 630, and the pin 640 connects the limiting member 630 to the optical fiber plug 620. The pin 640 may run through the optical fiber plug 620, a left end of the pin 640 may protrude from a left end of the optical fiber plug 620, and a right end of the pin 640 may protrude from a right end of the optical fiber plug 620.

In some embodiments, the pin 640 may include an exposed portion 641. One end of the exposed portion 641 protrudes from a right end of a ferrule.

FIG. 29 is a schematic structural diagram of a pin according to some embodiments of the present disclosure. As shown in FIG. 29, the pin 640 may include a connecting portion 642, where the connecting portion 642 is located at the other end of the exposed portion 641. A diameter of the connecting portion 642 may be smaller than that of the exposed portion 641, and the limiting member 630 is clamped to the connecting portion 642. The limiting member 630 is configured to connect the pin 640 to the optical fiber plug 620.

The pin 640 may include an insertion portion 643, where the exposed portion 641 is connected to the insertion portion 643 via the connecting portion 642. The diameter of the exposed portion 641 may be greater than or equal to that of the insertion portion 643. The diameter of the insertion portion 643 is greater than that of the connecting portion 642. The number of pins 640 may be one or two.

FIG. 30 is a schematic structural diagram of an optical fiber protective portion according to some embodiments of the present disclosure. As shown in FIG. 30, the optical fiber adapter 601 may include an optical fiber protective portion 650, where a part of the optical fiber protective portion 650 is located inside the optical fiber plug 620, and another part of the optical fiber protective portion 650 protrudes out of the optical fiber plug 620 to protect the optical fiber ribbon 602 from excessive bending and breakage. The optical fiber ribbon 602 passes through an optical fiber insertion opening 653 of the optical fiber protective portion 650. The optical fiber insertion opening 653 runs through the optical fiber protective portion 650 along its left-right length direction. The optical fiber ribbon 602 can pass through the optical fiber insertion opening 653 and enter the interior of the clamping jaw.

The optical fiber protective portion 650 may include an embedded region 651, where the embedded region 651 is embedded inside the optical fiber plug 620 to seal a notch of the optical fiber plug 620.

The optical fiber protective portion 650 may include an exposed region 652, where the exposed region 652 is exposed outside the optical fiber plug 620. An outer wall of the embedded region 651 may protrude from an outer side wall of the exposed region 652, that is, a width of the embedded region 651 in an up-down direction may be greater than that of the exposed region 652 in the up-down direction, and a length of the embedded region 651 in a front-rear direction may be greater than that of the exposed region 652 in the front-rear direction. The embedded region 651 may be connected to the optical fiber plug 620 by an interference fit.

The optical fiber protective portion 650 may be made of a rubber material and may have a compressible characteristic. The optical fiber protective portion 650 may be made of a flexible protective material.

FIG. 31 is a schematic structural diagram of an optical fiber plug according to some embodiments of the present disclosure. As shown in FIG. 31, the optical fiber plug 620 may include a ferrule 621, where the ferrule 621 is embedded inside the clamping jaw 610, and the clamping jaw 610 may provide protection for the ferrule 621.

The optical fiber plug 620 may include a fixing portion 622, where an outer side wall of the fixing portion 622 may protrude from an outer side wall of the ferrule 621, that is, a width of the fixing portion 622 in the up-down direction may be greater than that of the ferrule 621 in the up-down direction, and a length of the fixing portion 622 in the front-rear direction may be greater than that of the ferrule 621 in the front-rear direction.

The fixing portion 622 has a third ferrule side surface 6223 facing away from the ferrule 621, and the third ferrule side surface 6223 is in contact with one end surface of the limiting member 630.

In some embodiments, an outer side wall of the limiting member 630 may protrude from the outer side wall of the fixing portion 622, that is, a width of the limiting member 630 in the up-down direction may be greater than that of the fixing portion 622 in the up-down direction, and a length of the limiting member 630 in the front-rear direction may be greater than that of the fixing portion 622 in the front-rear direction.

The third ferrule side surface 6223 of the optical fiber plug 620 may be provided with a pin hole 6222, and the pin hole 6222 runs through the fixing portion 622 and the ferrule 621 of the optical fiber plug 620. When the optical fiber plug 620 is inserted into the light-transmitting hole 6130 of the clamping jaw 610, the optical fiber plug 620 extends into the light-transmitting hole 6130. An insertion portion 643 at one end of the pin 640 passes through a second through hole 631 and the pin hole 6222, and enters the light-transmitting hole 6130 after passing through the fixing portion 622 and the ferrule 621.

In some embodiments, the third ferrule side surface 6223 may be provided with a protective hole 6221. One end of the optical fiber protective portion 650 may extend into the fixing portion 622 via the protective hole 6221. The optical fiber protective portion 650 may be connected to the protective hole 6221 by an interference fit. In some embodiments, the embedded region 651 is in interference fit with the protective hole 6221. To facilitate mounting and fixation, the hardness of the optical fiber protective portion 650 may be less than that of the optical fiber plug 620.

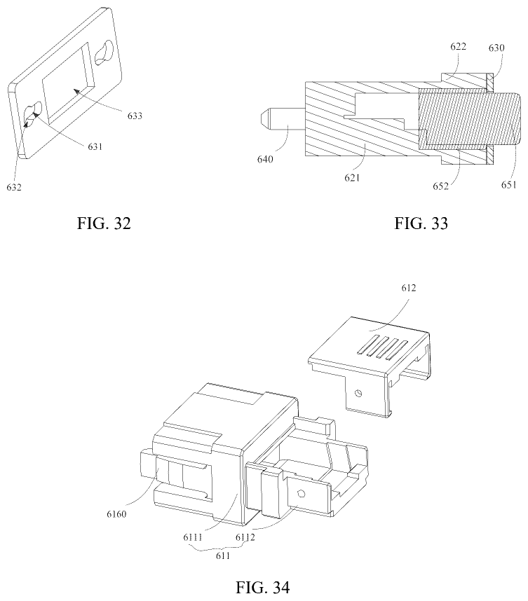

FIG. 32 is a schematic structural diagram of a limiting member according to an embodiment of the present disclosure, and FIG. 33 is a schematic cross-sectional view of a combination of a limiting member, an optical fiber protective portion, an optical fiber plug, and a pin according to an embodiment of the present disclosure. As shown in FIG. 32 and FIG. 33, the limiting member 630 may include a clearance hole 633, where the optical fiber protective portion 650 can enter the optical fiber plug 620 via the clearance hole 633. The optical fiber protective portion 650 can be inserted into the optical fiber plug 620.

The optical fiber ribbon can pass through the clearance hole 633 and be inserted into the fixing portion 622 to achieve optical fiber connection between the optical transceiver component and the optical fiber adapter 601.

The optical fiber protective portion 650 may be connected to the clearance hole 633 by an interference fit, such that the optical fiber protective portion 650 is filled in the clearance hole 633, thereby reducing a gap between the clearance hole 633 and the optical fiber protective portion 650, and effectively preventing dust from entering the optical module via the gap between the clearance hole 633 and the optical fiber protective portion 650. To facilitate mounting and fixation, the hardness of the optical fiber protective portion 650 may be less than that of the limiting member 630.

The limiting member 630 may be provided with a first through hole 632.

The limiting member 630 may be provided with a second through hole 631, and the first through hole 632 is in communication with the second through hole 631. A diameter of the first through hole 632 may be greater than that of the second through hole 631. The pin 640 may pass through the second through hole 631.

The limiting member 630 may be disposed between a side wall of the optical fiber plug 620 and the inner wall of the clamping jaw.

In some embodiments, to facilitate removal of the pin 640, the diameter of the exposed portion 641 may be greater than that of the first through hole 632. Thus, when the pin 640 is inserted into the pin hole 6222 of the optical fiber plug 620 via the first through hole 632, the exposed portion 641 is exposed outside the limiting member 630, and the pin 640 can move left and right in the pin hole 6222 and the first through hole 632; and then the limiting member 630 is moved to snap the connecting portion 642 into the second through hole 631, in which case the pin 640 cannot move left and right in the second through hole 631, thereby clamping the pin 640 to the limiting member 630.

In some embodiments, the optical fiber plug 620 may be an MT male plug, and the external optical fiber plug 701 is a corresponding MT female plug. That is, after the pin 640 is fixed to the optical fiber plug 620, one end of the pin 640 facing away from the exposed portion 641 protrudes from the optical fiber plug 620, such that when the external optical fiber plug 701 is inserted into the clamping jaw 610, the protruding pin 640 is inserted into a jack in an end face of the external optical fiber plug 701, thereby achieving positioning connection between the optical fiber plug 620 and the external optical fiber plug 701.

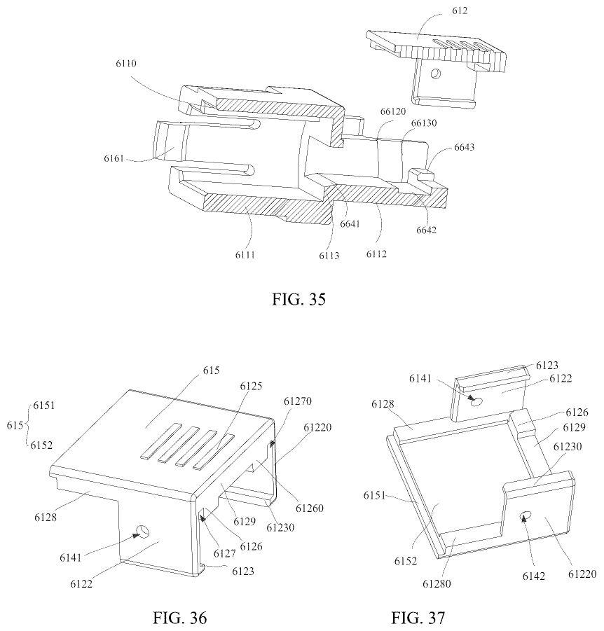

FIG. 34 is a schematic exploded view of a clamping jaw in an optical fiber adapter according to an embodiment of the present disclosure. FIG. 35 is a schematic cross-sectional view of a clamping jaw in an optical fiber adapter according to an embodiment of the present disclosure. As shown in FIG. 34 and FIG. 35, in some embodiments, the clamping jaw includes: a lower clamping jaw shell 611, where the lower clamping jaw shell is provided with a through light-transmitting hole 6130, and the light-transmitting hole 6130 runs through the lower clamping jaw shell 611 along its length direction, such that the external optical fiber and the optical fiber plug 620 are connected in the light-transmitting hole 6130.

The clamping jaw 610 may include an upper clamping jaw shell 612, where the upper clamping jaw shell 612 may be fixedly connected to the lower clamping jaw shell 611. The upper clamping jaw shell 612 may be covered on the lower clamping jaw shell 611, and the light-transmitting hole 6130 may run through a shell formed by the upper clamping jaw shell 612 and the lower clamping jaw shell 611. The optical fiber plug 620 may be filled in the light-transmitting hole 6130.

The lower clamping jaw shell 611 may include a fixing component 6111. The fixing component 6111 is configured to accommodate the external optical fiber plug 701 of the external optical fiber 710. The light-transmitting hole 6130 runs through the fixing component 6111.

The lower clamping jaw shell 611 may include a support component 6112. The support component 6112 is connected to the fixing component 6111, and the light-transmitting hole 6130 runs through both the fixing component 6111 and the support component 6112.

An upper surface of the support component 6112 is provided with an opening, and the opening is in communication with a light-transmitting hole of the fixing component 6111. The upper clamping jaw shell 612 may be engaged with the support component 6112, such that the upper clamping jaw shell 612 is located above the support component 6112.

FIG. 36 is a first-angle schematic structural diagram of an upper clamping jaw shell in an optical fiber adapter according to an embodiment of the present disclosure. FIG. 37 is a second-angle schematic structural diagram of an upper clamping jaw shell in an optical fiber adapter according to an embodiment of the present disclosure. As shown in FIG. 36 and FIG. 37, the upper clamping jaw shell 612 may include an upper shell cover plate 615, where the upper shell cover plate 615 may be covered on the support component 6112. The upper shell cover plate 615 may cover the opening in the upper surface of the support component 6112.

The upper clamping jaw shell 612 may include a first upper shell side plate 6122, where the first upper shell side plate 6122 is located on one side of the upper shell cover plate 615. The first upper shell side plate 6122 may be connected to the upper shell cover plate 615. The first upper shell side plate 6122 may be connected to an outer wall of the support component 6112.

The upper clamping jaw shell 612 may include a second upper shell side plate 61220, where the second upper shell side plate 61220 is located on one side of the upper shell cover plate 615. The second upper shell side plate 61220 may be connected to the upper shell cover plate 615. The second upper shell side plate 61220 may be connected to the outer wall of the support component 6112. The second upper shell side plate 61220 and the first upper shell side plate 6122 are oppositely disposed on both sides of the upper shell cover plate 615.

An inner wall of the second upper shell side plate 61220 may be connected to the outer wall of the support component 6112, and an inner wall of the first upper shell side plate 6122 may be connected to the outer wall of the support component 6112.

In some embodiments, the first upper shell side plate 6122 may be provided with a first mounting hole 6141. The first mounting hole 6141 can run through the first upper shell side plate 6122. The first mounting hole 6141 may be a blind hole that is recessed outward relative to the inner wall of the first upper shell side plate 6122. Here, the blind hole refers to a hole with a sealed end. The first mounting hole 6141 may be a circular hole. Certainly, the first mounting hole 6141 is not limited to a circular structure, for example, the first mounting hole 6141 may be a square hole.

In some embodiments, the second upper shell side plate 61220 may be provided with a second mounting hole 61410. The second mounting hole 61410 can run through the second upper shell side plate 61220. The second mounting hole 61410 may be a blind hole that is recessed outward relative to the inner wall of the second upper shell side plate 61220. Here, the blind hole refers to a hole with a sealed end. The second mounting hole 61410 may be a circular hole. Certainly, the second mounting hole 61410 is not limited to a circular structure, for example, the second mounting hole 61410 may be a square hole.

The upper clamping jaw shell 612 may include a first upper shell guard plate 6123, where the first upper shell guard plate 6123 may be formed by bending the first upper shell side plate 6122 inward. The first upper shell guard plate 6123 protrudes toward the interior of the light-transmitting hole relative to the first upper shell side plate 6122.

The upper clamping jaw shell 612 may include a second upper shell guard plate 61230, where the second upper shell guard plate 61230 may be formed by bending the second upper shell side plate 61220 inward. The second upper shell guard plate 61230 protrudes toward the interior of the light-transmitting hole relative to the second upper shell side plate 61220.

The upper shell cover plate 615 of the upper clamping jaw shell 612 may be provided with a shielding groove 6151, and the shielding groove 6151 is recessed relative to an inner wall of an upper shell cover plate body.

The upper shell cover plate 615 of the upper clamping jaw shell 612 may be provided with a body recess portion 6152. The body recess portion is located on a lower surface of the upper shell cover plate facing the support component of the lower clamping jaw shell.

The upper shell cover plate 615 of the upper clamping jaw shell 612 may be provided with a first upper shell support arm 6128, and the first upper shell support arm 6128 is located on one side of the body recess portion 6152. The first upper shell side plate 6122 is connected to the first upper shell support arm 6128.

A thickness of the first upper shell support arm 6128 is greater than that of the first upper shell side plate 6122. A length of the first upper shell support arm 6128 in the front-rear direction is greater than that of the first upper shell side plate 6122 in the front-rear direction, such that the first upper shell support arm 6128 is less likely to deform under force.

The upper shell cover plate 615 of the upper clamping jaw shell 612 may be provided with a second upper shell support arm 61280, and the second upper shell support arm 61280 is located on one side of the body recess portion 6152. The second upper shell side plate 61220 is connected to the second upper shell support arm 61280. The first upper shell support arm 6128 and the second upper shell support arm 61280 may be oppositely disposed on both sides of the body recess portion 6152.

A thickness of the second upper shell support arm 61280 is greater than that of the second upper shell side plate 61220. A length of the second upper shell support arm 61280 in the front-rear direction is greater than that of the second upper shell side plate 61220 in the front-rear direction, such that the second upper shell support arm 61280 is less likely to deform under force.

The upper shell cover plate 615 of the upper clamping jaw shell 612 may be provided with an upper shell blocking arm 6129. The upper shell blocking arm 6129 is located at one end away from the shielding groove 6151. The upper shell blocking arm 6129 may protrude inward relative to the body recess portion 6152. The upper shell blocking arm 6129 may protrude downward relative to the body recess portion 6152 (referring to FIG. 8). The upper shell blocking arm 6129 may be configured to increase a thickness of the upper shell cover plate 615, thereby reducing a degree of deformation of the upper shell cover plate 615 under force. The upper shell blocking arm 6129 may be configured to reduce a size of the light-transmitting hole at that location, thereby preventing entry of dust.

A first protruding portion 6126 may be disposed below the upper shell blocking arm 6129. The first protruding portion 6126 may protrude downward relative to the upper shell blocking arm 6129 (or protrude toward the support component of the upper clamping jaw shell). A lower surface of the first protruding portion 6126 may be lower than an upper surface of the optical fiber protective portion 650, a side wall of the optical fiber protective portion 650 may abut against an inner wall of the first protruding portion 6126, and the first protruding portion 6126 may limit movement of the optical fiber protective portion 650 in a left-right direction.

The lower surface of the first protruding portion 6126 may be lower than an upper surface of the exposed region 652, a side wall of the exposed region 652 may abut against the inner wall of the first protruding portion 6126, and the first protruding portion 6126 may limit movement of the exposed region 652 in the front-rear direction.

A height of the lower surface of the first protruding portion 6126 may be greater than or equal to that of a highest point of an upper surface of the pin 640, so as to avoid affecting mounting and removal of the pin 640.

The height of the lower surface of the first protruding portion 6126 may be greater than or equal to that of a highest point of an upper surface of the exposed portion 641, so as to avoid affecting mounting and removal of the pin 640.

A first mounting slot 6127 may be formed between the first protruding portion 6126 and the first upper shell side plate 6122. The first mounting slot 6127 is configured to match the lower clamping jaw shell. A side wall (e.g., the first support side plate described below) of the lower clamping jaw shell may be embedded between the first protruding portion 6126 and the first upper shell side plate 6122. The side wall of the lower clamping jaw shell may be embedded in the first mounting slot 6127.

The first protruding portion 6126 may have a certain blocking effect for dust, thereby enhancing the sealing effect at the optical port, and preventing the dust from entering the optical module.

A second protruding portion 61260 may be disposed below the upper shell blocking arm 6129. The second protruding portion 61260 may protrude downward relative to the upper shell blocking arm 6129.

A second mounting slot 61270 may be formed between the second protruding portion 61260 and the second upper shell side plate 61220. The second mounting slot 61270 is configured to match the lower clamping jaw shell. A side wall (e.g., the second support side plate described below) of the lower clamping jaw shell may be embedded between the second protruding portion 61260 and the second upper shell side plate 61220. The side wall of the lower clamping jaw shell may be embedded in the second mounting slot 61270.

A lower surface of the second protruding portion 61260 may be lower than the upper surface of the exposed region 652, the side wall of the exposed region 652 may abut against an inner wall of the second protruding portion 61260, and the second protruding portion 61260 may limit movement of the exposed region 652 in the left-right direction.

A height of the lower surface of the second protruding portion 61260 may be greater than or equal to that of the highest point of the upper surface of the pin 640 at the corresponding position, so as to avoid affecting mounting and removal of the pin 640.

The height of the lower surface of the second protruding portion 61260 may be greater than or equal to that of the highest point of the upper surface of the exposed portion 641, so as to avoid affecting mounting and removal of the pin 640.

In some embodiments, a first clearance portion is formed at a recess between the second protruding portion 61260 and the first protruding portion 6126. The exposed region 652 of the optical fiber protective portion 650 is exposed outside the optical fiber plug 620 via the first clearance portion.

In some embodiments of the present disclosure, the first upper shell side plate 6122 is located outside the lower clamping jaw shell, and the second upper shell side plate 61220 is located outside the lower clamping jaw shell. The first upper shell guard plate 6123 may be located outside a lower outer wall of the lower clamping jaw shell. The second upper shell guard plate 61230 may be located outside the lower outer wall of the lower clamping jaw shell.

The first upper shell guard plate 6123 may be located outside a lower outer wall of the support component 6112. The second upper shell guard plate 61230 may be located outside the lower outer wall of the support component 6112.

The limiting member 630 abuts against a left side of the upper shell blocking arm 6129 of the upper clamping jaw shell 612, and a lower surface of the upper shell blocking arm 6129 is lower than an upper surface of the limiting member 630.

In some embodiments, the upper shell cover plate 615 may include an anti-slip component 6125. The anti-slip component 6125 protrudes outward relative to a surface of the upper shell cover plate 615. The anti-slip component 6125 may be one or more strip-shaped protrusions. The anti-slip component 6125 may be protrusions of other shapes. The anti-slip component 6125 protrudes outward relative to an upper surface of the body recess portion 6152.

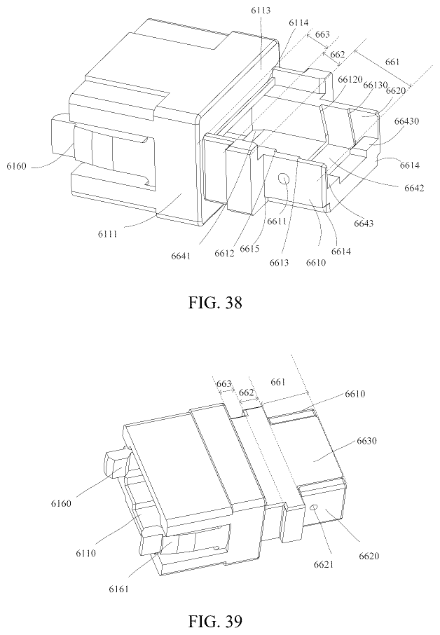

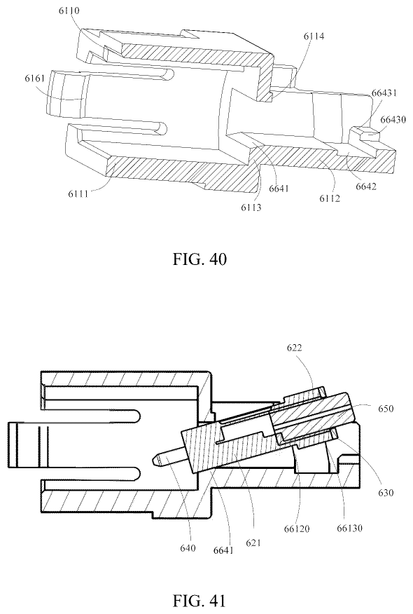

FIG. 38 is a first-angle schematic structural diagram of a lower clamping jaw shell in an optical fiber adapter according to an embodiment of the present disclosure. FIG. 39 is a second-angle schematic structural diagram of a lower clamping jaw shell in an optical fiber adapter according to an embodiment of the present disclosure. FIG. 40 is a schematic cross-sectional view of a lower clamping jaw shell in an optical fiber adapter according to an embodiment of the present disclosure. As shown in FIG. 38, FIG. 39, and FIG. 40, in some embodiments, the fixing component 6111 may be of a cavity structure with two open ends, where one open end thereof (referred to as a first open end for ease of description) is configured as an entry channel for the external optical fiber plug 701 of the external optical fiber 710, and the other open end thereof (referred to as a second open end for ease of description and opposite to the first open end) is in communication with the opening of the support component 6112.

One side surface of the fixing component 6111 may be provided with a first open slot, one end of the first open slot is provided with an opening, a first elastic latch 6160 may be disposed in the first open slot, and one end of the first elastic latch 6160 is fixedly connected to the fixing component 6111, such that the first elastic latch 6160 can open and close with a fixed end as a pivot point, thereby allowing the first elastic latch 6160 to expand outward or clamp inward. When the external optical fiber enters the light-transmitting hole 6130 from one side provided with the first elastic latch 6160, the first elastic latch 6160 expands outward. After the external optical fiber reaches a preset position, the first elastic latch 6160 clamps inward.

In some embodiments, the other side surface of the fixing component 6111 may be provided with a second open slot, one end of the second open slot is provided with an opening, a second elastic latch 6161 may be disposed in the second open slot, and one end of the second elastic latch 6161 is fixedly connected to the fixing component 6111, such that the second elastic latch 6161 can open and close with a fixed end as a pivot point, thereby allowing the second elastic latch 6161 to expand outward or clamp inward. When the external optical fiber enters the light-transmitting hole 6130 from one side provided with the second elastic latch 6161, the second elastic latch 6161 expands outward. After the external optical fiber reaches the preset position, the second elastic latch 6161 clamps inward.

The first elastic latch 6160 and the second elastic latch 6161 may be disposed oppositely. The external optical fiber is subjected to balanced forces when passing through the first elastic latch 6160 and the second elastic latch 6161. This can prevent low coupling efficiency caused by unbalanced forces on the external optical fiber.

In some embodiments, an inner side wall of the fixing component 6111 facing the external optical fiber may be provided with a mounting groove 6110. The mounting groove 6110 may be configured to guide the external optical fiber plug to be inserted into the light-transmitting hole 6130, that is, when the external optical fiber is inserted into the light-transmitting hole 6130 of the clamping jaw 610, the external optical fiber plug 701 can be inserted into the clamping jaw 610 along the mounting groove 6110 and be clamped by the clamping jaw 610, so as to achieve clamping connection between the external optical fiber plug 701 and the clamping jaw 610.

The mounting groove 6110 may be recessed in a direction facing away from the light-transmitting hole to increase a length of the light-transmitting hole at the mounting groove 6110 in the up-down direction.

In some embodiments, an inner wall of the fixing component 6111 may be provided with a first step 6113. A cross-sectional area of the light-transmitting hole located on a left side of the first step 6113 is greater than that of the light-transmitting hole located on a right side of the first step 6113.

The first step 6113 may be a connection interface between the fixing component 6111 and the support component 6112, and the first step 6113 causes an area of the light-transmitting hole at a corresponding position of the support component 6112 to be smaller than that of the light-transmitting hole at a corresponding position of the fixing component 6111.

The support component 6112 may include a support arm clamping region 661, where the support arm clamping region 661 is in clamped connection with the upper clamping jaw shell 612.

The support component 6112 may include a support arm protruding region 662, where an outer side wall of the support arm protruding region 662 may protrude from an outer side wall of the support arm clamping region 661. A width of the support arm protruding region 662 in the up-down direction may be greater than that of the support arm clamping region 661 in the up-down direction, and a length of the support arm protruding region 662 in the front-rear direction may be greater than that of the support arm clamping region 661 in the front-rear direction.

The support component 6112 may include a support arm connecting region 663, where the support arm clamping region 661 is connected to the support arm connecting region 663 via the support arm protruding region 662.

The width of the support arm protruding region 662 in the up-down direction may be greater than that of the support arm connecting region 663 in the up-down direction, and the length of the support arm protruding region 662 in the front-rear direction may be greater than that of the support arm connecting region 663 in the front-rear direction.

A lower surface of the support arm protruding region 662 may not protrude, and the width of the support arm protruding region 662 in the up-down direction may not be greater than that of the support arm connecting region 663 in the up-down direction.

In some embodiments, an outer side wall of the support arm connecting region 663 may protrude from the outer side wall of the support arm clamping region 661. A width of the support arm connecting region 663 in the up-down direction may be greater than that of the support arm clamping region 661 in the up-down direction, and a length of the support arm connecting region 663 in the front-rear direction may be greater than that of the support arm clamping region 661 in the front-rear direction.

The support arm protruding region 662, the support arm connecting region 663, and the support arm clamping region 661 are divisions of the support component 6112 along the left-right length direction.

The support component 6112 may include a support bottom plate 6630.

The support component 6112 may include a first support side plate 6610, where the first support side plate 6610 may be located on one side of the support bottom plate 6630, and the first support side plate 6610 forms a certain angle with the support bottom plate 6630. The first support side plate 6610 may be disposed perpendicular to the support bottom plate 6630.

In some embodiments, the first upper shell side plate 6122 of the upper clamping jaw shell 612 may be located on an outer side of the first support side plate 6610. The inner wall of the first upper shell side plate 6122 may be connected to an outer wall of the first support side plate 6610. The inner wall of the first upper shell side plate 6122 may be connected to an outer wall of the support arm clamping region 661 of the first support side plate 6610.

The outer wall of the first support side plate 6610 may be provided with a first connecting protrusion 6611. The first connecting protrusion 6611 may protrude relative to the outer wall of the first support side plate 6610. The first connecting protrusion 6611 may be disposed in the support arm clamping region 661 of the first support side plate 6610. The first mounting hole 6141 may be engaged with the first connecting protrusion 6611. The first connecting protrusion 6611 can pass through the first mounting hole 6141, such that the first upper shell side plate 6122 is connected to the first support side plate 6610, thereby connecting the upper clamping jaw shell 612 to the lower clamping jaw shell 611.

In some examples, the first connecting protrusion 6611 may be disposed on the first upper shell side plate 6122. The first mounting hole 6141 may be formed in the support arm clamping region 661 of the first support side plate 6610.

The support component 6112 may include a second support side plate 6620, where the second support side plate 6620 may be located on the other side of the support bottom plate 6630. The second support side plate 6620 and the first support side plate 6610 may be disposed on two opposite sides of the support bottom plate 6630.

The second support side plate 6620 forms a certain angle with the support bottom plate 6630. The second support side plate 6620 may be disposed perpendicular to the support bottom plate 6630. The second support side plate 6620 and the first support side plate 6610 may be structurally symmetrical to each other.

In some embodiments, the second upper shell side plate 61220 of the upper clamping jaw shell 612 may be located on an outer side of the second support side plate 6620. The inner wall of the second upper shell side plate 61220 may be connected to an outer wall of the second support side plate 6620. The inner wall of the second upper shell side plate 61220 may be connected to the outer wall of the support arm clamping region 661 of the second support side plate 6620.

The outer wall of the second support side plate 6620 may be provided with a second connecting protrusion 6621. The second connecting protrusion 6621 may protrude relative to the outer wall of the second support side plate 6620. The second connecting protrusion 6621 may be disposed in the support arm clamping region 661 of the second support side plate 6620. The second mounting hole 6142 may be engaged with the second connecting protrusion 6621. The second connecting protrusion 6621 can pass through the second mounting hole 6142, such that the first upper shell side plate 6122 is connected to the second support side plate 6620, thereby connecting the upper clamping jaw shell 612 to the lower clamping jaw shell 611.

In some examples, the second connecting protrusion 6621 may be disposed on the second upper shell side plate 61220. The second mounting hole 6142 may be disposed on the outer wall of the second support side plate 6620.

An inner wall of the first support side plate may be provided with a first support step 6612, and a left side of the first support step 6612 protrudes from a right side of the first support step 6612.

A first ferrule side surface 6224 of the fixing portion 622 is embedded in the right side of the first support step 6612, and a step surface between the first ferrule side surface 6224 of the fixing portion 622 and the ferrule 621 abuts against the first support step 6612. The first support step 6612 may limit the position of the fixing portion 622 in the left-right direction, which facilitates mounting. The first support step 6612 can provide guidance for the fixing portion 622.

The first support step 6612 may be disposed obliquely, and a distance between an upper end of the first support step 6612 and the fixing component 6111 may be smaller than a distance between a lower end of the first support step 6612 and the fixing component 6111. That is, the upper end of the first support step 6612 is disposed more to the left than the lower end of the first support step 6612.

An inner wall of the second support side plate may be provided with a second support step 66120, and a left side of the second support step 66120 protrudes from a right side of the second support step 66120.

A second ferrule side surface 6225 of the fixing portion 622 is embedded in the right side of the second support step 66120, and a step surface between the second ferrule side surface 6225 of the fixing portion 622 and the ferrule 621 abuts against the second support step 66120. The second support step 66120 may limit the position of the fixing portion 622 in the left-right direction, which facilitates mounting.

The second support step 66120 may be disposed obliquely, and a distance between an upper end of the second support step 66120 and the fixing component 6111 may be smaller than a distance between a lower end of the second support step 66120 and the fixing component 6111. That is, the upper end of the second support step 66120 is disposed more to the left than the lower end of the second support step 66120. The second support step 66120 can provide guidance for the fixing portion 622.

During mounting, the optical fiber plug 620, the limiting member 630, the pin 640, and the optical fiber protective portion 650 can be connected. The optical fiber plug 620 is inserted into the lower clamping jaw shell 611 from the upper opening of the support component 6112 in a top-to-bottom manner. During mounting, the first ferrule side surface 6224 of the fixing portion 622 is in contact with the first support side plate 6610 of the lower clamping jaw shell 611. The second ferrule side surface 6225 of the fixing portion 622 is in contact with the second support side plate 6620 of the lower clamping jaw shell 611. A left side surface of the fixing portion 622 abuts against the first support step 6612 and the second support step 66120, thereby limiting relative positions of the fixing portion 622 and the lower clamping jaw shell 611 in the left-right direction. The oblique arrangement of the first support step 6612 facilitates mounting of the optical fiber plug 620.

In some embodiments, the support component 6112 may include a transition portion 6641. The transition portion 6641 may be disposed on one side of the support bottom plate 6630 close to the fixing component 6111. Along a direction from the fixing component 6111 to the support component 6112 (from left to right), the transition portion 664 gradually inclines upward. During mounting, a lower surface of the optical fiber plug 620 can be inserted obliquely along the transition portion 664. A left end of the transition portion 664 (one end adjacent to the fixing component 6111) is lower than a right end of the transition portion 664.

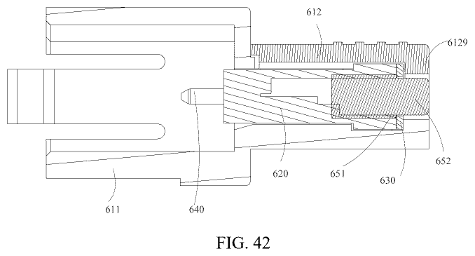

FIG. 41 is a schematic diagram of a mounting process for an optical fiber adapter according to some embodiments of the present disclosure. FIG. 42 is a second schematic cross-sectional view of an optical fiber adapter in an optical module according to some embodiments of the present disclosure. As shown in FIG. 41 and FIG. 42, during mounting, the optical fiber plug 620, the limiting member 630, the pin 640, and the optical fiber protective portion 650 can be connected. The optical fiber plug 620 is inserted into the lower clamping jaw shell 611 from the upper opening of the support component 6112 in a top-to-bottom manner. During mounting, the first ferrule side surface 6224 of the fixing portion 622 is in contact with the first support side plate 6610 of the lower clamping jaw shell 611. The second ferrule side surface 6225 of the fixing portion 622 is in contact with the second support side plate 6620 of the lower clamping jaw shell 611. The left side surface of the fixing portion 622 abuts against the first support step 6612 and the second support step 66120, thereby limiting the relative positions of the fixing portion 622 and the lower clamping jaw shell 611 in the left-right direction. The oblique arrangement of the first support step 6612 facilitates mounting of the optical fiber plug 620. The lower surface of the optical fiber plug 620 can be inserted obliquely along the transition portion 664. The left end of the transition portion 664 (one end adjacent to the fixing component 6111) is lower than the right end of the transition portion 664.

In some embodiments, the inner wall of the first support side plate may be provided with a third support step 6613, and a left side of the third support step 6613 protrudes from a right side of the third support step 6613.

The limiting member 630 is embedded in the right side of the third support step 6613, and a left side surface of the limiting member 630 can abut against the third support step 6613. The third support step 6613 may limit the position of the limiting member 630 in the left-right direction, which facilitates mounting.

The third support step 6613 may be disposed obliquely, and a distance between an upper end of the third support step 6613 and the fixing component 6111 may be smaller than a distance between a lower end of the third support step 6613 and the fixing component 6111. That is, the upper end of the third support step 6613 is disposed more to the left than the lower end of the third support step 6613.

In some embodiments, an inclination angle of the third support step 6613 may be the same as that of the first support step 6612.

The third support step 6613 may be located on the right side of the first support step 6612 (in a direction facing away from the fixing component 6111).

The inner wall of the second support side plate may be provided with a fourth support step 66130, and a left side of the fourth support step 66130 protrudes from a right side of the fourth support step 66130.

The limiting member 630 is embedded in the right side of the fourth support step 66130, and the left side surface of the limiting member 630 can abut against the fourth support step 66130. The fourth support step 66130 may limit the position of the limiting member 630 in the left-right direction, which facilitates mounting.

The fourth support step 66130 may be disposed obliquely, and a distance between an upper end of the fourth support step 66130 and the fixing component 6111 may be smaller than a distance between a lower end of the fourth support step 66130 and the fixing component 6111. That is, the upper end of the fourth support step 66130 is disposed more to the left than the lower end of the fourth support step 66130.

In some embodiments, an inclination angle of the fourth support step 66130 may be the same as that of the second support step 66120.

The fourth support step 66130 may be located on the right side of the second support step 66120 (in the direction facing away from the fixing component 6111).

During mounting, the optical fiber plug 620, the limiting member 630, the pin 640, and the optical fiber protective portion 650 can be connected. The optical fiber plug 620 and the limiting member 630 are inserted into the lower clamping jaw shell 611 from the upper opening of the support component 6112 in a top-to-bottom manner. During mounting, the first ferrule side surface 6224 of the fixing portion 622 is in contact with the first support side plate 6610 of the lower clamping jaw shell 611. The second ferrule side surface 6225 of the fixing portion 622 is in contact with the second support side plate 6620 of the lower clamping jaw shell 611. The left side surface of the fixing portion 622 abuts against the first support step 6612 and the second support step 66120, thereby limiting the relative positions of the fixing portion 622 and the lower clamping jaw shell 611 in the left-right direction. The oblique arrangement of the first support step 6612 facilitates mounting of the optical fiber plug 620. A left side wall of the limiting member 630 can abut against the third support step 6613 and the fourth support step 66130. The front and rear side walls of the limiting member 630 abut against the inner walls of the second support side plate and the first support side plate.

A side baffle 6114 may be disposed between the first support side plate 6610 and the second support side plate 6620. One side of the side baffle 6114 may be connected to the fixing component 6111. A side wall of the fixing component 6111 may extend outward to form the side baffle 6114. The side baffle 6114 abuts against the shielding groove 6151, which can increase a contact area between the upper clamping jaw shell 612 and the lower clamping jaw shell 611, and can extend a path for dust or air to enter the light-transmitting hole via a gap between the upper clamping jaw shell 612 and the lower clamping jaw shell 611. The side baffle 6114 abuts against the shielding groove 6151, which can enhance the sealing performance of the optical fiber adapter.

The side baffle 6114 abuts against the shielding groove 6151, which can increase the contact area between the upper clamping jaw shell 612 and the lower clamping jaw shell 611, reduce deformation of the upper clamping jaw shell 612 under force during mounting, and enhance the sealing performance of the optical fiber adapter.

The side baffle 6114 may be disposed between the inner wall of the first support side plate 6610 and the inner wall of the second support side plate 6620.

The lower clamping jaw shell may include a bottom plate groove 6642. The bottom plate groove 6642 may be recessed relative to an upper surface of the support bottom plate 6630. The bottom plate groove 6642 may be configured to fix the optical fiber plug 620, and the bottom plate groove 6642 may limit the position of the optical fiber plug 620 in the left-right length direction. The fixing portion 622 may be located in the bottom plate groove 6642, and the bottom plate groove 6642 may limit the position of the fixing portion 622 in the left-right length direction.

In some embodiments, a position of a left side wall of the bottom plate groove 6642 in the left-right direction is consistent with that of the first support step 6612 in the left-right direction. During the process in which the optical fiber plug 620 is inserted into the clamping jaw from the opening of the support component 6112, the first ferrule side surface 6224 of the fixing portion 622 of the optical fiber plug is embedded in the right side of the first support step 6612, and the step surface between the first ferrule side surface 6224 of the fixing portion 622 and the ferrule 621 abuts against the first support step 6612, until a bottom surface of the fixing portion 622 is embedded in the bottom plate groove 6642.

In some embodiments, the limiting member 430 may be located in the bottom plate groove 6642, and the bottom plate groove 6642 may limit the position of the limiting member 430 in the left-right length direction. The fixing portion 622 and the limiting member 430 may be located in the bottom plate groove 6642, and the bottom plate groove 6642 may limit the positions of the fixing portion 622 and the limiting member 430 in the left-right length direction.

The support arm clamping region 661 of the first support side plate 6610 may include a first sliding slot 6614. The first upper shell guard plate 6123 is clamped in the first sliding slot 6614, and the first upper shell guard plate 6123 slides from right to left along the first sliding slot 6614, such that the upper clamping jaw shell 612 is gradually connected to the lower clamping jaw shell 611 from the right side, and finally the side baffle 6114 is located in the shielding groove 6151; and the first connecting protrusion 6611 is located in the first mounting hole 6141, thereby achieving fixation between the upper clamping jaw shell 612 and the lower clamping jaw shell 611.

The first sliding slot 6614 is located on a lower surface of the first support side plate 6610, and the first sliding slot 6614 may cause the lower surface of the first support side plate 6610 to be higher than a lower surface of the support bottom plate 6630, such that after mounting, a lower surface of the first upper shell guard plate 6123 is flush with the lower surface of the support bottom plate 6630.

In some embodiments, the first support side plate 6610 may be provided with a first upper shell support portion 6615. The first upper shell support portion 6615 protrudes relative to the lower surface of the first support side plate 6610, which increases its distance from the upper shell cover plate 615 of the upper clamping jaw shell, tensions the upper shell cover plate 615, and prevents separation of the upper shell cover plate 615 from the lower clamping jaw shell 611.

The support arm clamping region 661 of the second support side plate 6620 may include a second sliding slot. The second upper shell guard plate 61230 is clamped in the second sliding slot, and the second upper shell guard plate 61230 slides from right to left along the second sliding slot, such that the upper clamping jaw shell 612 is gradually connected to the lower clamping jaw shell 611 from the left side, and finally the side baffle 6114 is located in the shielding groove 6151; and the second connecting protrusion 6621 is located in the second mounting hole 6142, thereby achieving fixation between the upper clamping jaw shell 612 and the lower clamping jaw shell 611.

The second sliding slot is located on a lower surface of the second support side plate, and the second sliding slot may cause the lower surface of the second support side plate 6620 to be higher than the lower surface of the support bottom plate 6630, such that after mounting, the lower surface of the second upper shell guard plate 61230 is flush with the lower surface of the support bottom plate 6630.

In some embodiments, the second support side plate 6620 may be provided with a second upper shell support portion. The second upper shell support portion protrudes relative to the lower surface of the second support side plate 6620, which increases its distance from the upper shell cover plate 615 of the upper clamping jaw shell, tensions the upper shell cover plate 615, and prevents separation of the upper shell cover plate 615 from the lower clamping jaw shell 611. The second upper shell support portion is adjacent to the support arm protruding region 662.

In some embodiments, the support bottom plate may be provided with a first lower shell baffle 6643. The first lower shell baffle 6643 may protrude relative to the upper surface of the support bottom plate and is located at one end of the support bottom plate away from the fixing component (or opposite to the transition portion). A left side wall of the first lower shell baffle 6643 may abut against a right side wall of the optical fiber plug 620 (when the limiting member 630 is absent).

In some embodiments, the left side wall of the first lower shell baffle 6643 may abut against a right side wall of the limiting member 630, and the first lower shell baffle 6643 may limit the positions of the optical fiber plug 620 and the limiting member 630 in the left-right direction. The bottom surface of the fixing portion 622 may be embedded in the bottom plate groove 6642, and a bottom surface of the limiting member 630 may be embedded in the bottom plate groove 6642.

In some examples, an upper surface of the first lower shell baffle 6643 may be higher than a lower surface of the exposed region 652, the side wall of the exposed region 652 may abut against an inner wall of the first lower shell baffle 6643, and the first lower shell baffle 6643 may limit the movement of the exposed region 652 in the front-rear direction. A height of the upper surface of the first lower shell baffle 6643 may be smaller than or equal to that of a lowest point of a lower surface of the pin 640, so as to avoid affecting mounting and removal of the pin 640.

The height of the upper surface of the first lower shell baffle 6643 may be smaller than or equal to that of a lowest point of a lower surface of the exposed portion 641, so as to avoid affecting mounting and removal of the pin 640.

The first lower shell baffle 6643 may be connected to the first support side plate 6610 to seal the optical port, thereby preventing entry of dust.

In some embodiments, the support bottom plate may be provided with a second lower shell baffle 66430. The second lower shell baffle 66430 may protrude relative to the inner wall of the support bottom plate. A left side wall of the second lower shell baffle 66430 may abut against the right side wall of the optical fiber plug 620 (when the limiting member 630 is absent).

In some embodiments, the left side wall of the second lower shell baffle 66430 may abut against the right side wall of the limiting member 630, and the second lower shell baffle 66430 may limit the positions of the optical fiber plug 620 and the limiting member 630 in the left-right direction. The bottom surface of the fixing portion 622 may be embedded in the bottom plate groove 6642, and a bottom surface of the limiting member 630 may be embedded in the bottom plate groove 6642.

In some examples, an upper surface of the second lower shell baffle 66430 may be higher than the lower surface of the exposed region 652, the side wall of the exposed region 652 may abut against an inner wall of the second lower shell baffle 66430, and the second lower shell baffle 66430 may limit the movement of the exposed region 652 in the front-rear direction. A height of the upper surface of the second lower shell baffle 66430 may be smaller than or equal to that of the lowest point of the lower surface of the pin 640, so as to avoid affecting mounting and removal of the pin 640.

In some embodiments, a left side wall of the second lower shell baffle 66430 may be provided with a baffle inclined surface 66431, which can guide the optical fiber plug 620.

The height of the upper surface of the second lower shell baffle 66430 may be smaller than or equal to that of the lowest point of the lower surface of the exposed portion 641, so as to avoid affecting mounting and removal of the pin 640.

The second lower shell baffle 66430 may be connected to the second support side plate 6620 to seal the optical port, thereby preventing entry of dust.

For ease of description, a rightmost end of the light-transmitting hole formed by the upper clamping jaw shell 612 and the lower clamping jaw shell 611 is referred to as a right light-transmitting hole. The limiting member 630 abuts against the inner wall forming the right light-transmitting hole, and a width of the limiting member 630 in the front-rear direction is greater than that of the right light-transmitting hole in the front-rear direction, which can prevent dust from entering the ferrule via a gap between the right light-transmitting hole and the exposed region 652 in the front-rear direction.

The width of the limiting member 630 in the up-down direction is greater than that of the right light-transmitting hole in the up-down direction, which can prevent dust from entering the ferrule via a gap between the right light-transmitting hole and the exposed region 652 in the up-down direction.

In some embodiments, a width of the fixing portion 622 in the front-rear direction is greater than that of the right light-transmitting hole in the front-rear direction, which can prevent dust from entering the ferrule via the gap between the right light-transmitting hole and the exposed region 652 in the front-rear direction.

The width of the fixing portion 622 in the up-down direction is greater than that of the right light-transmitting hole in the up-down direction, which can prevent dust from entering the ferrule via the gap between the right light-transmitting hole and the exposed region 652 in the up-down direction.

In some embodiments of the present disclosure, one end of the optical fiber protective portion 650 may extend into the fixing portion 622 via the protective hole 6221.

The pin 640 may be connected to the limiting member 630, the connecting portion 642 may be snapped into the second through hole 631, and the exposed portion 641 may be exposed outside the limiting member 630. Subsequently, the insertion portion 643 is inserted into the pin hole 6222, and the insertion portion 643 at one end of the pin 640 passes through the second through hole 631 and the pin hole 6222, and enters the light-transmitting hole 6130 via the fixing portion 622 and the ferrule 621. The exposed region 652 is exposed on a right side of the limiting member 630 via the clearance hole 633. The optical fiber protective portion 650 may be connected to the clearance hole 633 by an interference fit, such that the optical fiber protective portion 650 is filled in the clearance hole 633, thereby reducing the gap between the clearance hole 633 and the optical fiber protective portion 650, and effectively preventing dust from entering the optical module via the gap between the clearance hole 633 and the optical fiber protective portion 650.

For ease of description, a plug assembly may include a pin 640, a limiting member 630, an optical fiber plug 620, and an optical fiber protective portion 650.

When the plug assembly is inserted into the lower clamping jaw shell 611 from above the opening of the support component 6112, the lower surface of the optical fiber plug 620 may be obliquely inserted along the transition portion 664; the first ferrule side surface 6224 of the fixing portion 622 may be embedded in the right side of the first support step 6612, and the step surface between the first ferrule side surface 6224 of the fixing portion 622 and the ferrule 621 abuts against the first support step 6612; and the fixing portion 622 may slide into the clamping jaw along an inclined surface of the first support step 6612 in a top-to-bottom manner.

The second ferrule side surface 6225 of the fixing portion 622 is embedded in the right side of the second support step 66120, and the step surface between the second ferrule side surface 6225 of the fixing portion 622 and the ferrule 621 abuts against the second support step 66120. The fixing portion 622 may slide into the clamping jaw along an inclined surface at the second support step 66120 in a top-to-bottom manner.

The optical fiber plug 620 is inserted into the lower clamping jaw shell 611 from the upper opening of the support component 6112 in a top-to-bottom manner. During mounting, the first ferrule side surface 6224 of the fixing portion 622 is in contact with the first support side plate 6610 of the lower clamping jaw shell 611. The second ferrule side surface 6225 of the fixing portion 622 is in contact with the second support side plate 6620 of the lower clamping jaw shell 611. The left side surface of the fixing portion 622 abuts against the first support step 6612 and the second support step 66120, thereby limiting the relative positions of the fixing portion 622 and the lower clamping jaw shell 611 in the left-right direction. The oblique arrangement of the first support step 6612 facilitates mounting of the optical fiber plug 620. The optical fiber ribbon 602 can pass through the optical fiber insertion opening 653 and enter the interior of the clamping jaw.

The position of the left side wall of the bottom plate groove 6642 in the left-right direction is consistent with that of the first support step 6612 in the left-right direction. During the process in which the optical fiber plug 620 is inserted into the clamping jaw from the opening of the support component 6112, the first ferrule side surface 6224 of the fixing portion 622 of the optical fiber plug is embedded in the right side of the first support step 6612, and the step surface between the first ferrule side surface 6224 of the fixing portion 622 and the ferrule 621 abuts against the first support step 6612, until the bottom surface of the fixing portion 622 is embedded in the bottom plate groove 6642.

When the bottom surface of the fixing portion 622 is embedded in the bottom plate groove 6642, the exposed region 652 of the optical fiber protective portion 650 is located between the first lower shell baffle 6643 and the second lower shell baffle 66430.

After the plug assembly is clamped in the lower clamping jaw shell 611, the upper clamping jaw shell 612 is inserted into the lower clamping jaw shell 611 from the right end. The first upper shell support arm 6128 may slide into the lower clamping jaw shell from the right end along an upper surface of the first support side plate 6610. The second upper shell support arm 61280 may slide into the lower clamping jaw shell from the right end along an upper surface of the second support side plate 6620. Until the side baffle 6114 abuts against the shielding groove 6151, the sealing performance of the optical fiber adapter can be enhanced. The first connecting protrusion 6611 is located in the first mounting hole 6141, thereby achieving fixation between the upper clamping jaw shell 612 and the lower clamping jaw shell 611. The second connecting protrusion 6621 is located in the second mounting hole 6142, thereby achieving fixation between the upper clamping jaw shell 612 and the lower clamping jaw shell 611. The upper shell cover plate 615 of the upper clamping jaw shell 612 covers the upper opening of the lower clamping jaw shell 611, such that the upper clamping jaw shell and the lower clamping jaw shell form a sealed structure with a light-transmitting hole only in the left-right direction, which can effectively prevent dust from entering the clamping jaw from the up-down and the front-rear directions. The optical fiber protective portion 650 may be connected to the clearance hole 633 by an interference fit, such that the optical fiber protective portion 650 is filled in the clearance hole 633, thereby reducing the gap between the clearance hole 633 and the optical fiber protective portion 650, and effectively preventing dust from entering the optical module via the gap between the clearance hole 633 and the optical fiber protective portion 650, and from entering the clamping jaw from the left-right direction.

The optical fiber protective portion 650 and the upper clamping jaw shell 612 form a gap above the exposed region 652, the limiting member 630 abuts against the left side of the upper shell blocking arm 6129 of the upper clamping jaw shell 612, and the lower surface of the upper shell blocking arm 6129 is lower than the upper surface of the limiting member 630, thereby shielding the gap above the exposed region 652.

The optical fiber protective portion 650 and the lower clamping jaw shell 611 form a gap below the exposed region 652, the limiting member 630 abuts against a left side of a right side wall of the bottom plate groove 6642, and an upper surface of the right side wall of the bottom plate groove 6642 is higher than a lower surface of the limiting member 630, thereby shielding the gap below the exposed region 652.

In some embodiments, the limiting member 630 is embedded between the first support side plate 6610 and the second support side plate 6620, and the limiting member 630 abuts against the third support step 6613, thereby shielding a gap formed behind the exposed region 652 and preventing entry of dust. The limiting member 630 abuts against the fourth support step 66130, thereby shielding a gap formed in front of the exposed region 652 and preventing entry of dust.

In some embodiments, the fixing portion 622 is embedded between the first support side plate 6610 and the second support side plate 6620, and the fixing portion 622 abuts against the first support step 6612, thereby shielding the gap formed behind the exposed region 652 and preventing entry of dust. The fixing portion 622 abuts against the second support step 66120, thereby shielding the gap formed in front of the exposed region 652 and preventing entry of dust.

In some embodiments, a length of the clearance hole 633 in the up-down direction is smaller than that of the rightmost end of the light-transmitting hole formed by the upper clamping jaw shell 612 and the lower clamping jaw shell 611 in the up-down direction, and the limiting member 630 seals a gap formed by the exposed region 652 and the clamping jaw 610, which can effectively prevent dust from entering the ferrule 621 via the gap formed by the exposed region 652 and the clamping jaw 610.

A length of the clearance hole 633 in the front-rear direction is smaller than that of the rightmost end of the light-transmitting hole formed by the upper clamping jaw shell 612 and the lower clamping jaw shell 611 in the front-rear direction, and the limiting member 630 seals the gap formed by the exposed region 652 and the clamping jaw 610, which can effectively prevent dust from entering the ferrule 621 in the clamping jaw via the gap formed by the exposed region 652 and the clamping jaw 610.

In some embodiments, the optical fiber protective portion 650 and the upper clamping jaw shell 612 form a gap above the exposed region 652, the fixing portion 622 abuts against the left side of the upper shell blocking arm 6129 of the upper clamping jaw shell 612, and the lower surface of the upper shell blocking arm 6129 is lower than the upper surface of the fixing portion 622, thereby shielding the gap above the exposed region 652.

The optical fiber protective portion 650 and the lower clamping jaw shell 611 form a gap below the exposed region 652, the fixing portion 622 abuts against the left side of the right side wall of the bottom plate groove 6642, and the upper surface of the right side wall of the bottom plate groove 6642 is higher than the lower surface of the fixing portion 622, thereby shielding the gap below the exposed region 652.

A length of the protective hole 6221 of the fixing portion 622 in the up-down direction is smaller than that of the rightmost end of the light-transmitting hole formed by the upper clamping jaw shell 612 and the lower clamping jaw shell 611 in the up-down direction, and the limiting member 630 seals the gap formed by the exposed region 652 and the clamping jaw 610, which can effectively prevent dust from entering the ferrule 621 via the gap formed by the exposed region 652 and the clamping jaw 610.

A length of the protective hole 6221 in the front-rear direction is smaller than that of the rightmost end of the light-transmitting hole formed by the upper clamping jaw shell 612 and the lower clamping jaw shell 611 in the front-rear direction, and the limiting member 630 seals the gap formed by the exposed region 652 and the clamping jaw 610, which can effectively prevent dust from entering the ferrule 621 in the clamping jaw via the gap formed by the exposed region 652 and the clamping jaw 610.

Finally, it should be noted that the above embodiments are provided merely to illustrate the technical solutions of the present disclosure and not to limit them. Although the present disclosure has been described in detail with reference to the aforementioned embodiments, those of ordinary skill in the art should understand that they can still make modifications on the technical solutions described in the aforementioned embodiments or make equivalent replacements on some of the technical features; and these modifications or replacements do not make the essence of the corresponding technical solutions depart from the spirit and scope of the technical solutions of the various embodiments of the present disclosure.

What is claimed is:

1. An optical module, comprising:
a circuit board; and
an optical transceiver component, electrically connected to the circuit board and configured to emit and receive an optical signal; and
an optical fiber adapter, having a first end connected to an external optical fiber plug of an external optical fiber, and a second end connected to the optical transceiver component via an optical fiber ribbon, wherein the second end of the optical fiber adapter is disposed opposite to the first end; and
wherein the optical fiber adapter comprises:
a lower clamping jaw shell, provided with a through light-transmitting hole, wherein the lower clamping jaw shell comprises:
a fixing component, configured to accommodate the external optical fiber plug of the external optical fiber, wherein the light-transmitting hole runs through the fixing component;
a support component, connected to the fixing component, wherein an upper surface of the support component is provided with an opening, and the opening is in communication with the light-transmitting hole; and
an upper clamping jaw shell, configured to cover the lower clamping jaw shell to form a clamping jaw with the light-transmitting hole, wherein the upper clamping jaw shell comprises:
an upper shell cover plate, configured to cover the opening of the support component;
upper shell side plates, connected to two opposite sides of the upper shell cover plate and configured to be connected to corresponding outer walls of the support component; and
an optical fiber plug, having one end fixedly connected to the optical fiber ribbon, and the other end inserted into the light-transmitting hole,
wherein the outer walls of the support component are provided with connecting protrusions protruding from the outer walls, the upper shell side plates are provided with corresponding mounting holes, and the connecting protrusions are embedded in the mounting holes such that the upper clamping jaw shell is connected to the lower clamping jaw shell.

2. The optical module according to claim 1, further comprising an optical fiber protective portion, wherein
the optical fiber protective portion has an optical fiber insertion opening that runs through the optical fiber protective portion along a length direction of the optical fiber protective portion, and the optical fiber protective portion is inserted into the optical fiber plug, such that the optical fiber ribbon is insertable through the optical fiber insertion opening into the clamping jaw;
the optical fiber protective portion comprises: an embedded region and an exposed region;
a width of the embedded region in an up-down direction is greater than a width of the exposed region in the up-down direction; a length of the embedded region in a front-rear direction is greater than a length of the exposed region in the front-rear direction; and
the optical fiber insertion opening runs through the embedded region and the exposed region.

3. The optical module according to claim 1, wherein
the upper shell side plates of the upper clamping jaw shell comprise a first upper shell side plate and a second upper shell side plate disposed on the two opposite sides of the upper shell cover plate, and the mounting holes comprise a first mounting hole formed in the first upper shell side plate and a second mounting hole formed in the second upper shell side plate; and
the support component comprises a support bottom plate and a first support side plate and a second support side plate respectively disposed on two opposite sides of the support bottom plate, and the connecting protrusions comprise a first connecting protrusion disposed on an outer wall of the first support side plate and a second connecting protrusion disposed on an outer wall of the second support side plate.

4. The optical module according to claim 1, wherein the upper clamping jaw shell comprises:
an upper shell guard plate, connected to the upper shell side plates and protruding toward an interior of the upper clamping jaw shell; and
a lower part of the support component is provided with a sliding slot, and the upper shell guard plate is slidable in the sliding slot such that the upper clamping jaw shell is connected to the lower clamping jaw shell.

5. The optical module according to claim 1, wherein the lower clamping jaw shell comprises:
a side baffle, located above the upper surface of the support component, and having one side connected to the fixing component;
a lower surface of the upper shell cover plate facing the support component of the lower clamping jaw shell is provided with a shielding groove; and the side baffle is embedded in the shielding groove.

6. The optical module according to claim 3, wherein the support bottom plate of the support component is provided with a transition portion; and one end of the transition portion is connected to the fixing component, and the transition portion is gradually inclined upward along a direction from the fixing component to the support component.

7. The optical module according to claim 6, wherein the support bottom plate of the support component is provided with a baffle protruding relative to an upper surface of the support bottom plate, and the baffle is located at one end of the support bottom plate opposite to the transition portion.

8. The optical module according to claim 7, wherein the support bottom plate of the support component is provided with a bottom plate groove recessed relative to the upper surface of the support bottom plate, and the bottom plate groove is adjacent to the baffle; and a fixing portion of the optical fiber plug is embedded in the bottom plate groove.

9. The optical module according to claim 8, wherein along a direction away from the fixing component, a first support step and a third support step are sequentially disposed on an inner wall of the first support side plate, and a second support step and a fourth support step are sequentially disposed on an inner wall of the second support side plate, wherein the first support step and the second support step, the third support step and the fourth support step, and the baffle limit a position of the fixing portion of the optical fiber plug embedded in the bottom plate groove.

10. The optical module according to claim 9, wherein a position of a left side wall of the bottom plate groove in a left-right direction is consistent with positions of the first support step and the second support step in the left-right direction.

11. The optical module according to claim 3, wherein a lower surface of the upper shell cover plate of the upper clamping jaw shell facing the support component is provided with: a body recess portion; and a first upper shell support arm and a second upper shell support arm located on two opposite sides of the body recess portion, wherein the first upper shell side plate is connected to the upper shell cover plate via the first upper shell support arm, and the second upper shell side plate is connected to the upper shell cover plate via the second upper shell support arm.

12. The optical module according to claim 11, wherein the lower surface of the upper shell cover plate is further provided with an upper shell blocking arm, and the upper shell blocking arm is disposed between the first upper shell support arm and the second upper shell support arm at one end of the upper shell cover plate away from the fixing component;
the upper shell blocking arm is provided with a first protruding portion and a second protruding portion that protrude toward the support component relative to the upper shell blocking arm, and the first protruding portion and the second protruding portion are respectively located at two ends of the upper shell blocking arm close to the first upper shell support arm and the second upper shell support arm; and
the optical module further comprises an optical fiber protective portion, wherein the optical fiber protective portion is inserted into the optical fiber plug, and the first protruding portion and the second protruding portion are configured to limit a position of the optical fiber protective portion.

13. The optical module according to claim 12, wherein a first mounting slot is formed between the first protruding portion and the first upper shell side plate, and the first support side plate of the lower clamping jaw shell is embedded in the first mounting slot; and a second mounting slot is formed between the second protruding portion and the second upper shell side plate, and the second support side plate of the lower clamping jaw shell is embedded in the second mounting slot.

14. The optical module according to claim 12, wherein a first clearance portion is formed at a recess between the second protruding portion and the first protruding portion, and an exposed region of the optical fiber protective portion is exposed via the first clearance portion.

15. The optical module according to claim 2, wherein
the optical fiber plug comprises a ferrule and a fixing portion connected to each other, wherein an outer side wall of the fixing portion protrudes from an outer side wall of the ferrule; the ferrule is inserted into the light-transmitting hole, an end surface of the fixing portion away from the ferrule is provided with a protective hole, and one end of the optical fiber protective portion extends into the fixing portion via the protection hole; and
the optical module further comprises a limiting member disposed in the clamping jaw, wherein the limiting member has one end in contact with the end surface of the fixing portion away from the ferrule, and the other end in contact connection with the lower clamping jaw shell.

16. The optical module according to claim 15, wherein the limiting member comprises a clearance hole, wherein the embedded region of the optical fiber protective portion is inserted into the optical fiber plug via the clearance hole and is connected to the optical fiber plug by an interference fit.

17. The optical module according to claim 1, further comprising: a pin, configured to connect the limiting member and the optical fiber plug.

18. The optical module according to claim 17, wherein the pin comprises an exposed portion, a connecting portion, and an insertion portion, wherein the exposed portion is connected to the insertion portion via the connecting portion; and the exposed portion is exposed outside the limiting member, and the insertion portion is inserted through the optical fiber plug.

19. The optical module according to claim 1, wherein the fixing component is of a cavity structure with two open ends, wherein a first open end thereof is configured as an entry channel for the external optical fiber plug of the external optical fiber, and an opposite second open end thereof is in communication with the opening of the support component.

20. The optical module according to claim 19, wherein the fixing component comprises a first elastic latch and a second elastic latch disposed on opposite side surfaces of the fixing component, wherein one end of each of the first elastic latch and the second elastic latch is fixedly connected to the fixing member, and the other end thereof is a free end, such that when the external optical fiber plug of the external optical fiber is inserted into the light-transmitting hole from the first open end of the fixing component, the first elastic latch and the second elastic latch expand outward, and after the external optical fiber plug reaches a preset position, the first elastic latch and the second elastic latch clamp inward.
